(19) United States
(12) Patent Application Publication
(10) Pub. No.: US 2001/0051876 A1
(43) Pub. Date: Dec. 13, 2001

(54) System and method for personalizing, customizing and distributing geographically distinctive products and travel information over the internet

(76) Inventors: Ronald E. Seigel, Los Angeles, CA (US); Alexandra N. Seigel, Los Angeles, CA (US); John Ullmen, Los Angeles, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/825,637

(22) Filed: Apr. 3, 2001

Related U.S. Application Data
(60) Provisional application No. 60/194,239, filed on Apr. 3, 2000.
(60) Provisional application No. 60/197,652, filed on Apr. 17, 2000.
(60) Provisional application No. 60/218,624, filed on Jul. 17, 2000.

(51) Int. Cl. G06F 17/60

(52) U.S. Cl. 705/1

(57) ABSTRACT

A method of using a computer for selecting content by categorizing attributes of a user in a user database, categorizing attributes of content elements in a content database, identifying a geographic location, identifying a user, and prioritizing content elements associated with the identified geographic location for presentation to the identified user by comparing the attributes of the content and the attributes of the identified user.

### CROSS-REFERENCE TO RELATED APPLICATIONS

This application claims priority of U.S. Provisional Application Nos. 60/194,239 filed on Apr. 3, 2000, 60/197,652 filed on Apr. 17, 2000, and 60/218,624 filed on Jul. 17, 2000, the entire contents of which are incorporated herein by reference.

### FIELD OF THE INVENTION

This invention relates generally to computerized product sales and information distribution and, more particularly, to the selecting and displaying of geographically distinctive products and travel information as a function of several factors, including a geographic location and a user's profile.

### BACKGROUND OF THE INVENTION

As travel means have become faster, easier and cheaper, more people have begun traveling. Many travelers enjoy sending postcards to friends and family to let those they care about know that they are thinking about them. Often, these postcards show something about the place that the sender is visiting so that the recipient of the postcard gets some appreciation for the place.

Unfortunately, traditional postcards are often costly, especially if there are many recipients. Traditional mail postcards take some time to reach their destination, especially if the place where they are being sent from is far from home. Sometimes, the sender has already returned from their trip before the postcard arrives home. Mailing a postcard from a foreign country can sometimes be quite an ordeal because the traveler may not speak the language of the country and needs to obtain the postcard, proper postage, and submit the postcard for mailing.

Also, a traveler often encounters something related to the place that they are visiting that they would like to send home or tell others about. The great variety of foods, clothes, and other cultural institutions around the world leads to a great diversity of items for sale. Travelers are often starved for time. Yet they still want to show they care about their friends, family or business associates by purchasing geographically distinctive gifts that have personal relevance to the recipient. Unfortunately, travelers are often unable to find the perfect gift quickly, and they are often unable to carry the items with them on their return trip. From the traveler's perspective it may feel risky to pay to ship items home when the traveler is unsure that the people at home will be interested in the gift. Under time pressure, travelers often abandon the idea of travel gift giving altogether, due to the hassle of filling out tax forms and having to wait in long lines at customs.

Likewise, from a merchant perspective, it is hard to advertise unique items to a worldwide audience. The cost of acquiring the right customer for their goods can be expensive.

With the advent of the Internet and e-mail it is possible to send messages from one computer to another almost anywhere in the world almost instantly. This technology opens up new avenues for travelers to communicate with the people they care about back home. This technology also provides new ways for merchants to market and distribute their merchandise to potential consumers anywhere in the world.

The use of remote computers and machines to supply consumers with goods and services is becoming commonplace in modern society. Automatic teller machines (ATM's) are one example of remote machines that are located everywhere from airports to zoos. Electronic vending machines now dispense products ranging from stamps to coffee and are also located in a wide range of locations. People now turn to these remote machines in increasing frequency and with an ever increasing dependence.

However, many people fear computers and machines and avoid interaction with them. This fear is due in part to the complexity of the user's interface with the machine. Typically, the user interface design is dictated by the number of functions and commands available for the users. The more functions and commands, the more options are placed on the screen or buried in menus and sub-menus. For programming purposes, all users are treated the same and offered the same functions and commands. The design problem is not trivial, because computers and machines offer so many functions and commands that the user interface is laden with options for the user to select. This forces users to wade through a maze of menus and commands to operate the machine. Inexperienced users are subjected to a plethora of options that make no sense whatsoever to them. Overall, the experience is daunting and unrewarding. Of course programmers, realizing this problem, do attempt to tailor the user's interface so that the functions most often used are presented first. However, this approach falls short, and users are more inclined not to use the computer or machine.

The problem with the user interface also exists when machines and computers provide content to users; indeed, the problem is even more pronounced. For example, machines which allow connectivity to the Internet simply allow the user to drift rudderless in a sea of information. Some systems use a front page or a startup screen to help guide the users. Of course, this approach is simply a menu for users. Another approach taken is to limit the available content for users to a single set of information. This limited content approach is used in systems such as bridal registries where only bridal registry information is available to the user. In short, the problem of user interface complexity and the fear it causes users has been addressed by either limiting the user's information set to one element, or by not limiting it at all.

### SUMMARY OF THE INVENTION

In an embodiment of the present invention, attributes of a user are categorized in a user database. Additionally, attributes of content elements are categorized in a content database. Once a user and a geographic location are identified, content elements associated with the identified geographic location are prioritized for presentation to the identified user. The content elements are prioritized by comparing the attributes of the content associated with the identified geographic location to the attributes of the identified user. In an additional embodiment, attributes of geographic locations are categorized in a geographic location database. In this embodiment content elements are selected for the identified user by comparing the attributes of the content elements to attributes of the identified geographic location and to the attributes of the identified user.

In yet an additional embodiment, attributes of a user terminal are categorized in a database and content element are selected by comparing the attributes of the content elements to attributes of the identified geographic location, attributes of the identified user and attributes of the user terminal.

In another embodiment, each content element is assigned a source location and a destination location. Source and destination locations are identified, and content elements are selected based upon the source location and the destination location. Once sorted based on source and destination location, the content elements can be further sorted based upon at least user and terminal attributes.

An object of the present invention is to provide a system and method for selecting and communicating content to remote users based on the context of a terminal being used, a geographic location, and the user. Contexts are created for terminals, geographic locations, and users by incorporating a wide range of data and by making additional assumptions about that data based on any likely data correlations. By creating contexts, the present invention markedly improves the pertinence of products and information presented to users, thereby improving the quality and efficiency of the user's experience.

Another object of the present invention is to streamline the functionality of a user terminal's graphical user interface (“GUI”) to better focus the user's attention on primary functions. The GUI is optimized, using dynamic feedback from actual use by a user, to affect placement of items on the display, and to reduce the number of levels of menus a user must navigate to operate the terminal.

The context of the terminal being used by the user, also known as “Terminal Context”, refers to the type of access device through which the user interacts with the system. A “terminal” can be a kiosk, PC, laptop, web-enabled television, telephone, cellular phone, personal digital assistant, such as a Palm Pilot, etc. The Terminal Context is relevant, therefore, to determine how much content will be returned to the user, and in what format the content will be presented. For example, if the user is using a personal computer with a color monitor, the user will be provided with more graphic and media intensive content, then would be appropriate or possible if the user was using a cellular phone with a small black and white screen.

The Terminal Context is derived from a device profile that contains the hardware and software attributes of the device being used to access the system. The system uses the terminal context to customize the content to best fit within the hardware and software capabilities of the device used to access the system.

The context of the geographic location, also known as the “Geographic Location Context”, refers to the relevant geographic area for selecting content such as goods, services and information. For example, if a traveler is using the system to find a restaurant in a city in France, the relevant Geographic Location Context is France, and more specifically the city in which the traveler wants to find a restaurant.

Geographic Location Contexts, may be created using a wide range of data, or assumptions, based on such information as characteristics of a general geographic location (e.g., Napa Valley, Calif.). The Geographic Location Context is gleaned from a geographic location profile database structured as a tree with corresponding attributes.

The Geographic Location Context has two important fields, “Source” and “Destination”. For users choosing postcards, products, or services (for themselves, for another person, or for a group of people), the “Source” refers to the Geographic Location (e.g., country or region distinctively associated with the items; and “Destination” refers to the geographic location (e.g. city) to which the items will be sent. For example, a user who is visiting France might want to send a bottle of Bordeaux wine to a relative back home in Sydney, Australia. In this case, France would be the “Source” and Sydney would be the “Destination”.

Each postcard, product, service, etc., will have at least one “Source” associated with it, and at least one “Destination”. The existence of both “Source” and “Destination” fields in the Geographic Location Context allows the system to select a pre-sorted set of products, services, etc. specifically associated with any given “Source” location that can be quickly sent to any given “Destination” location. Since it is an object of the present invention to reduce the number of levels of menus a user must navigate to operate the terminal, this pre-sort feature establishes an essential time-saving method, not only for the selection of products to be displayed, but also for the fulfillment of orders and delivery of the products.

By merging the Geographic Location Context, the Terminal Context and the User Context (described below) it is possible to create a Personalized Geographic Shopping System, the format of which can be customized for various Internet connectivity devices. The Personalized Geographic Shopping System is a central feature of one embodiment of the present invention. It is, therefore, an object of that embodiment of the present invention is to allow individuals or businesses to purchase geographically distinctive products from around the world, products that the system selects and displays based on the preferences of the user, the type of Internet connectivity device used and the geographic location of the merchant or geographic derivation of the item.

The Geographic Location Context associated with travel information (as contrasted with postcards, products, services, etc., in the foregoing discussion) is simpler. For travel information, such as restaurant recommendations, there is only a “Source” location, i.e., the geographic location about which a user is interested in obtaining travel information.

It is possible for users to go on to make purchases related to the travel information they receive, in which case the user selects a “Destination” location. For example, a user researching a vacation in Hawaii, (Hawaii is specified as a “Source” location) may request product recommendations that are suitable for the trip. The Personalized Geographic Shopping System is hotlinked to the travel information about Hawaii. Using Hawaii as the “Source” location, the system recommends products such as a Hawaiian shirt and a tropical sunburn protection lotion, that can be immediately purchased and sent to the user's home in Alaska (the “Destination” location) before the user leaves on the trip.

As another example, a user might request restaurant recommendations in a given “Source” location, then decide to purchase a gift certificate for a friend to use at one of the restaurants. At that point the user would select a “Destination” for the location where the gift certificate will be sent. This is a method of monetizing, or generating revenues from the user's travel research session, i.e., linking Personalized Geographic Shopping (for geographically relevant items) directly with the presentation of travel information, which is another object of one embodiment of the present invention.

In one embodiment of the present invention, the “Source” geographic location value is acquired automatically by the presence of a global positioning device in the device being used to access the system. In an alternative embodiment, the relevant “Source” geographic location is determined by monitoring the broadcast signal of the user terminal's communication system and triangulating the user terminal's location. Alternatively, the relevant “Source” geographic location value is acquired from the telephone number dialed to access the Internet. Alternatively, the user specifies a relevant “Source” geographic location value.

In one embodiment of the present invention, the user specifies the “Destination” geographic location value. In another embodiment of the present invention, the “Destination” geographic location value defaults to the city in which the user resides.

The “User Context” refers to the characteristics and preferences of the system user. The use of a specific User Context allows the system to be tailored very specifically for each individual user. A user may have a User Context set up with the system, in which case the user is considered a “member”. If the user is not a member, the system has a default User Context and can select goods, services and information without the use of a specific User Context. If the user does not use a specific pre-established User Context, the system keeps track of the movements by a user within a session to form a temporary User Context for use within that session. The temporary User Context can be saved by the user in a personalized User Context at any time during the session. The movements of a “member” are also used to further customize the member's User Context.

User Contexts may be created from data about the user stored in a user profile database, including any preferences, selections or other general data collected or inferred from a past or present session, general assumptions from a past session or present session, personal user data such as age, sex, marital status, method used to purchase goods, home or work or delivery address, recreational interests, favorite foods or wines, etc. The user profile database is structured as a tree with corresponding attributes. The user profile database tree can be correlated with the geographic location profile database tree to select attributes in common.

The User Context may be constructed to have private elements that are inaccessible to anyone other than the user, as well as public elements that can be accessed by the system to answer queries from other users. In an additional embodiment, users can elect to share some or all of their User Context with other specific users, or groups of users. For example, a person can allow their spouse or other members of their family access to their gift purchases, and a person can allow their co-workers to see their business related information, but not their non-business related information.

The system uses any deliberate choice made by the user to customize or personalize the information they receive by selecting from a menu of options. For example, if a user requests an appropriate birthday gift from France for their seven year old daughter in the United States, the system should look for gifts that are appropriate for a seven year old girl, and that are appropriate for birthdays. Additionally, the system sets the relevant “Source” geographic location value to France and the “Destination” geographic location value to the United States. Accordingly, only items that are from France or associated with France, and shippable to the United States, are selected.

In another embodiment of the present invention, the user indicates their request by responding to various questions presented to them by the system. In an additional embodiment, the user submits a general question to the system, and the system parses the question looking for key words and phrases to determine the user's request. Additionally, a member can request certain types of goods and services that they wish to receive information about when they begin a session.

The content available to a user, such as goods, services and information, is also categorized in a profile system that correlates with the tree structure of the User Context, and the Geographic Location Context. For example, when a user is buying a gift, the content profile contains fields that correspond to attributes of a user's request, such as a type of gift, an occasion of the gift, a price range, the recommended age and sex of the content user, etc. Thus, the attributes of content available to a user can be used to locate the most relevant content.

The Terminal Context, the Geographic Location Context, the User Context, and a user's request are all combined to form a “Session Context”. The Session Context is used to select the content, such as goods, services, advertisements, and information, provided to a user. The Session Context is constantly changing based upon the changes in the Geographic Context, User Context and user requests. Examples of general Session Contexts include personal shopping sessions, gift shopping sessions for a friend, and corporate gift shopping sessions for an executive team.

An example of how the invention might be employed is within a remote kiosk system. The kiosk system may be a travel related kiosk that offers users the opportunity to obtain gift suggestions based on the User Profiles in the User Context database, purchase location specific gifts via the Personalized Geographic Shopping System, that are shipped home, to send electronic post cards related to the area in which the kiosk is located, and to access travel tips about the local area.

Another example of how the invention may be employed is as an electronic assistant. In this embodiment, the terminal is a personal computing device such as a digital organizer that communicates with a data server. The personal computing device functions as an electronic assistant that provides content and answers to questions asked by the user. In one embodiment, the electronic assistant is used to purchase goods and services, send gifts and postcards, and to obtain worldwide travel information from virtually anywhere in the world. However, in additional embodiments, the electronic assistant can be used for many other purposes, including information retrieval and commerce related activities such as creating customized travel books and customized travel magazines that can be hotlinked to the Personalized Geographic Shopping System.

It is an object of one embodiment of the present invention to allow users to send electronic “postcards” from a first device to a recipient using a second device, incorporating information and advertisements from the “Source” specified by the first user or sender of the postcard. In addition, upon receipt of the postcard, the recipient is invited to begin a geographic shopping session in one step (e.g. with a “single click”). If the recipient elects to go shopping, the recipient's “Source” defaults to the “Source” of the postcard. The “Destination” for the postcard recipient's geographic shopping session defaults to the “Destination” chosen by the postcard sender. Recipients can change either the “Source” location or the “Destination” location as they please.

It is another object of one embodiment of the present invention to allow individuals or businesses to create and purchase custom travel books. The travel books contain information about one or more geographic locations that is customized based upon relevant geographic location profiles, user profiles, user terminal profiles and specific user requests. Information contained in the travel books, including product and service recommendations can be hotlinked to the Personal Geographic Shopping System as described above.

It is another object of one embodiment of the present invention to allow individuals or businesses to create and purchase custom travel magazines. The travel magazines contain articles, goods, and information about one or more geographic locations that is customized based upon relevant geographic location profiles, user profiles, user terminal profiles and specific user requests. Geographically relevant advertisements (that match the preferences in the User Profiles contained in the User Context databases can be hotlinked directly to the Personalized Geographic Shopping System.

It is another object of one embodiment the present invention to allow individuals or businesses to purchase geographically distinctive products and services, and send electronic travel postcards while watching an interactive television broadcast or Webcast that is hotlinked to the Personalized Geographic Shopping System.

These and other aspects of the present invention are more readily understood when considered in conjunction with the accompanying drawings and the following detailed description.

### DESCRIPTION OF THE DRAWINGS

FIG. 1 is a block diagram of a system for distributing customized products and information according to an embodiment of the present invention.

FIG. 2 is a schematic diagram showing the interrelationship of components of a system for distributing customized products and information according to an embodiment of the present invention.

FIG. 3 is a schematic diagram showing the interrelationship of alternative components of a system for distributing customized products and information.

FIG. 4 is a block diagram of a server and database system employing distributed databases and distributed servers.

FIG. 5 is a block diagram of a terminal employing distributed databases and distributed servers.

FIG. 6 is a sample geographic location profile database record.

FIG. 7 is a sample user profile database record.

FIG. 8 is a sample content database record.

FIG. 9 is a flow diagram of the process of sending an electronic postcard.

FIG. 10 is an illustration of an electronic postcard according to an embodiment of the present invention.

FIG. 11 is a flow diagram of a process of electronic postcard design according to an embodiment of the present invention.

### DETAILED DESCRIPTION

Typical applications where the invention may be employed consist of a user terminal, which is a remote machine, such as a kiosk, personal computing device, or the like, which provides content to a user and allows the user to interact with the machine. In one embodiment, the user terminal communicates with a server which aids the remote machine in communicating content to a user. The server communicates with several databases containing data about users, the characteristics of the user terminal, the characteristics of other remote machines, geographic locations, and content. The data is used to dynamically select and tailor the products and information displayed to the contexts of the geographic location, user and the user terminal.

In the following embodiments of the invention, common reference numerals are used to represent the same components. If the features of an embodiment are incorporated into a single system, these components can be shared and perform all the functions of the described embodiments.

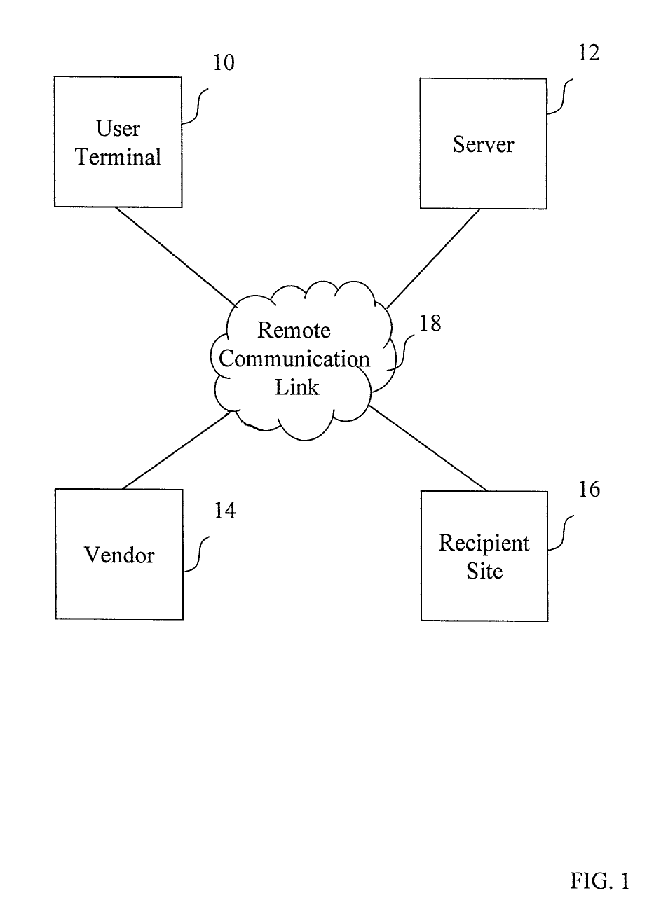

A system in accordance with the present invention is illustrated in FIG. 1. The system of FIG. 1 comprises a user terminal 10, including a device operated by the user, a server 12, a vendor site 14, and a receiver site 16, including a device operated by a receiver. The sender site, server site, vendor site, and receiver site all include computers, and are all coupled to each other via a remote communication link 18. In the embodiment described, the remote communication link comprises the Internet, although in alternative embodiments, the remote communication link comprises an Intranet or other computer to computer interface.

A user, at user terminal 10, contacts the server 12, through the remote communication link, to request content and to select content for the receiver site 16. Depending on the request from the user to the server 12, the server 12 may contact the vendor site 14 through the remote communication link to have a product shipped to the user. The server 12 can also send content selected by the user to the receiver site 16 through the remote communication link.

Computers often communicate with each other over the Internet using TCP/IP. In TCP/IP, packets of information, such as the digital data of an e-mail, are addressed to a given computer location. Each packet of data passes from one computer to the next in a global network until the packet of data reaches the address it was assigned. Typically e-mails are addressed to “someone someplace.” The someplace is translated into an IP address of a destination server by way of a DNS request. Upon receipt of the e-mail by the destination server, the destination server routes the e-mail to the appropriate recipient.

As seen in FIG. 1, the Internet allows entities distant from each other in space to engage in business transactions and co-marketing arrangements as if they were right next to each other. Additionally, the Internet allows someone to shop instantly for products manufactured in a distant geographic area.

In order to provide security over the Internet, communications can be encrypted using a key so that only someone who has the proper key can decrypt the communication and read its contents. Thus even though the communication is passed through the remote communication link described above, the communications are kept private as they pass through, thus forming a virtual private network. In one embodiment, communications between the sender site, server, recipient site and vendor are all conducted over a virtual private network using encryption.

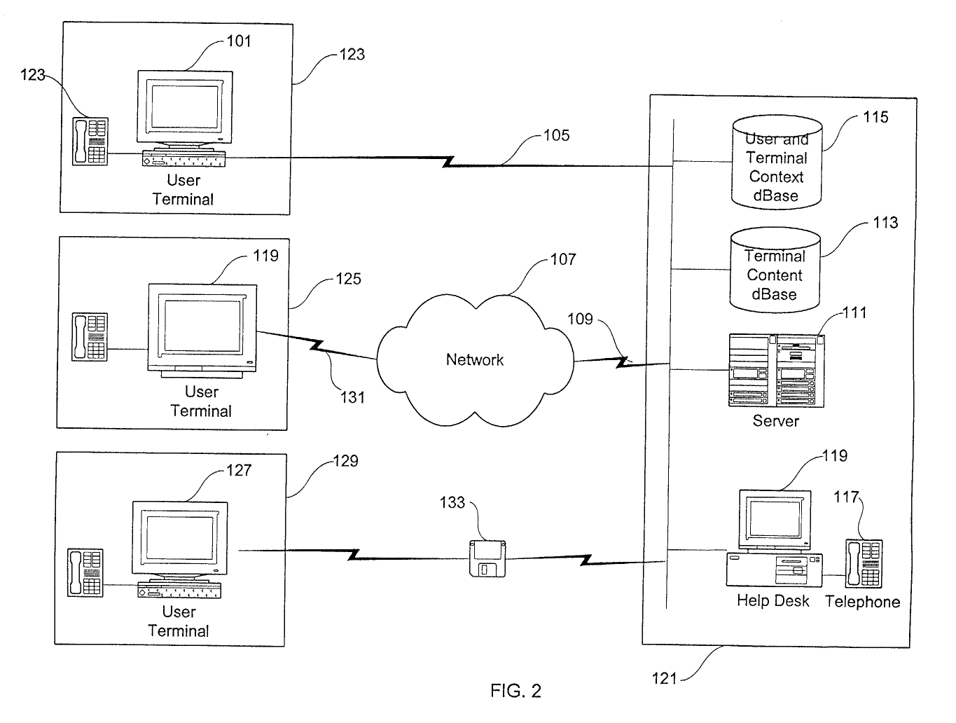

As shown in FIG. 2, several components work together to select and display the desired content to a remote user. A terminal 101, remote from the server 111, can be fitted into a kiosk designed for placement in locations such as retail stores, shopping malls, airports and airplanes, trains and train stations, buses and bus stations, cruise ships, and the like. The kiosk resembles an Automated Teller Machine (ATM) or other stand-alone business machine. Aside from a kiosk, a terminal 101 may be deployed in a variety of enclosures, including within a table for use while seated, mounted in an airplane, bus, or train seat-back, installed inside a television or entertainment center for use in hotels and cruise ships, mounted inside or on walls much like ATM machines, or as a stand alone apparatus similar to a vending machine or slot machine.

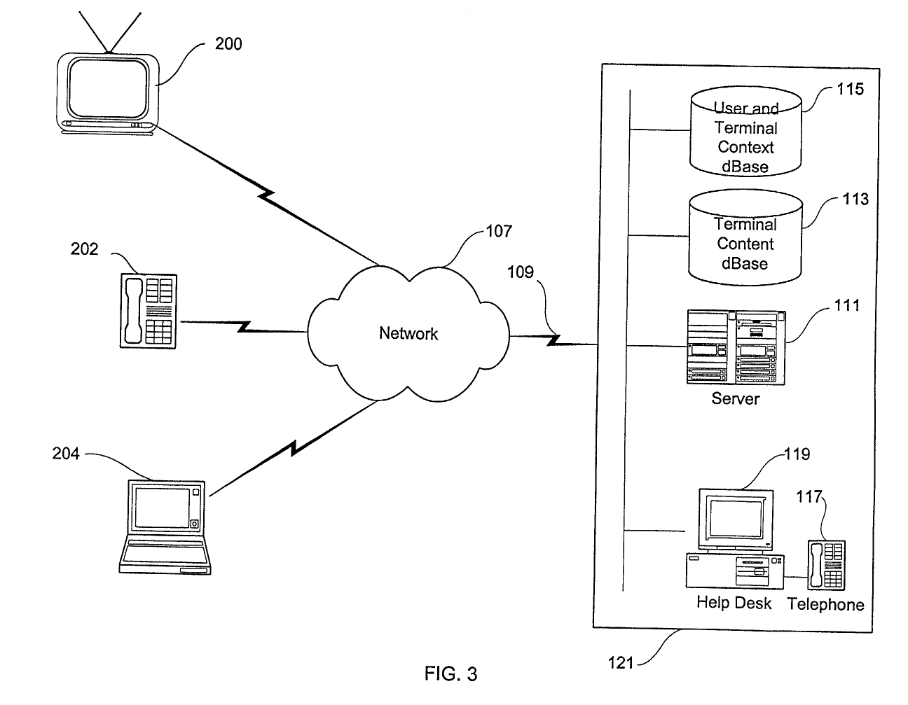

As shown in FIG. 3, in alternative embodiments, the terminal is a personal computing device such as a personal computer, a laptop computer 204, or a digital organizer. Alternatively, the terminal is a consumer electronic device such as a telephone 202, a television 200, or a set-top box.

The terminal 101 typically comprises a general-purpose computer such as an IBM PC or the like. The terminal 101 may employ hardware such as system memory, a storage device such as a hard disk drive or flash memory, a monitor, and one or more input devices such as a keyboard and a mouse. Additionally, as shown in FIG. 2, the terminal 101 may include a communications device such as a modem or network interface card to facilitate communications with the server 111 via a communications path 105. Additionally, the terminal 101 may include a printer for printing on paper or for printing of high quality photographs.

In an alternative embodiment, the terminal 101 monitor may also function as the primary or supplemental input device because the monitor's screen is touch sensitive. The touch screen allows the user to operate the terminal 101 by simply touching areas on the screen. For example, a virtual keyboard can be displayed on the screen and the user can type by touching the virtual keyboard on the screen.

In another embodiment of the invention, a terminal 119 may be limited to only a display and an input device linked which are connected via a communication channel 131 to the server. This embodiment utilizes commercially available computer components supporting the X-windows display platform.

The terminal's 101 software typically includes an operating system such as Windows, Linux, Mac OS, or Palm OS. Additionally, the terminal 101 may employ software such as an Internet web browser programmed to communicate with the server 111 to facilitate the user's session. In an alternative embodiment, the terminal 101, employs custom application software written specifically for the system to facilitate the user's session via the communications link 105 with the server 111. Further descriptions of the system's communications are described herein. The terminal 101 is programmed to provide a user interface thereby allowing interaction between the user and the system. In one embodiment, the terminal 101 is programmed to store data locally in one or more databases. In one embodiment, most of the needed data is stored local to the terminal so as to minimize the amount of data that is transmitted from the server 111 via the communications link 105. The terminal 101 may be reprogrammed remotely from the server 111 as needed. Additionally, the terminal may download needed data while the terminal 101 is not in use.

The terminal 101 may be fitted with a debit and credit card reader to facilitate financial transactions. This allows for monetary payments for a range of services such as purchasing gifts, gift certificates, services, or other fee based content elements. In an additional embodiment, the terminal has a currency reader capable of reading the currency of the place in which the terminal is situated so that local currency can be inserted to allow for monetary payment.

The system may also facilitate financial transactions by allowing the user to create a user account by storing the needed financial information within a user profile stored in a database 115. User accounts may be created either from a terminal 101 or via the Internet using a web-based interface. The system may also facilitate financial transactions by allowing the user to input financial data directly into the terminal 101 using the keyboard or other input devices.

The terminal 101 is typically coupled to a power supply for electrical power (e.g., 120 volts in the U.S.). Optionally, the terminal 101 may be powered using a battery, or alternative power sources such as solar power. The various options for powering the terminal 101 reflect the fact that the terminal 101 may be deployed in the widest range of applications and locations, and the deployment may be either permanent or temporary.

The communication link 105 between the terminal 101 and the server 111 is typically a land-based plain old telephone service (POTS), or other type of computer communications network such as ISDN, a dedicated T-1 circuit, satellite, ADSL, frame relay, or the like. In another embodiment, the terminal 101 may use a virtual private network (VPN) and a public packet switched data network 107, such as the Internet, to communicate with the server 111. Additionally, the terminal 127 may be programmed to operate independent of the server 111 for periods of time (e.g., without a communications link), instead of the typical communications link 105. The needed data can be pre-installed onto the terminal 127 or via a simple file transfer 133 before the terminal 127 is placed and/or after the terminal 127 is retrieved. Additionally, the terminal may upload and download data in organized batches either during user operation or during idle time. The independent mode of operation broadens the scope of locations, which may be served by the system. The various options for establishing a communications link reflect the fact that the terminal may be deployed in a wide range of applications and locations, and the deployment may be permanent or temporary. Additionally, some applications require a terminal be preprogrammed once, and no further communications are required. It will be clear to one skilled in the art that several types of terminals may be connected to the server using any one of a combination of communications links.

Many terminals 101 will also accommodate a traditional style telephone 123 for connecting users to a help desk 117. The telephone 123 will relay voice traffic between the terminal 101 and the help desk using one of a number of technologies, such as the voice over IP (a standard communications protocol widely supported by computer manufacturers) or Internet Phone (a proprietary system by Microsoft Corporation). As help calls come into the help desk, the help desk computer 119 is programmed to recognize which terminal 101 is calling for help, and if available, which user is using the terminal 101 by querying the server 111 and the User Profile database 115. If the terminal is not stationary, the help desk can acquire the terminal's location by looking at the Geographic Location Context being employed. Additionally, the help desk terminal may employ remote control software, such as Compaq Corporation's commercially available “Carbon Copy” software which allows a remote operator to literally “take control” of the remote terminal 101 as if they were sitting at the terminal. In another embodiment, the terminal's telephone 23 may connect to the help desk using traditional telephone service. The terminal's telephone 23 can be preprogrammed to dial a toll-free or direct dial telephone number when the user picks up the handset. It may also be programmed to signal an attendant at the call center to call the user at the terminal if certain conditions are met. For example, if a user is taking a longer time than expected to provide input or the user requests on-line help frequently, etc.

In an alternative embodiment, a microphone can be used to communicate the user's voice to “speech to text” software resident either on the device itself or on a server. Likewise, using speech synthesizing software, a description of goods, services, and information can be presented to a user through an audio system, rather than on a visual display screen. The ability to interpret and synthesize speech allows for handsfree use of the device. The handsfree use of the device increases suitability for use in vehicles and increases the number of applications and devices that the system can be used with.

In an additional embodiment, the system utilizes several different languages. Once the user is at a user terminal that is not already customized to them, the user indicates their presence by either pressing a button or touching the screen. In response to the signal by the user announcing their presence, the system provides a first screen to the user prompting them to choose a language for the terminal to display information in.

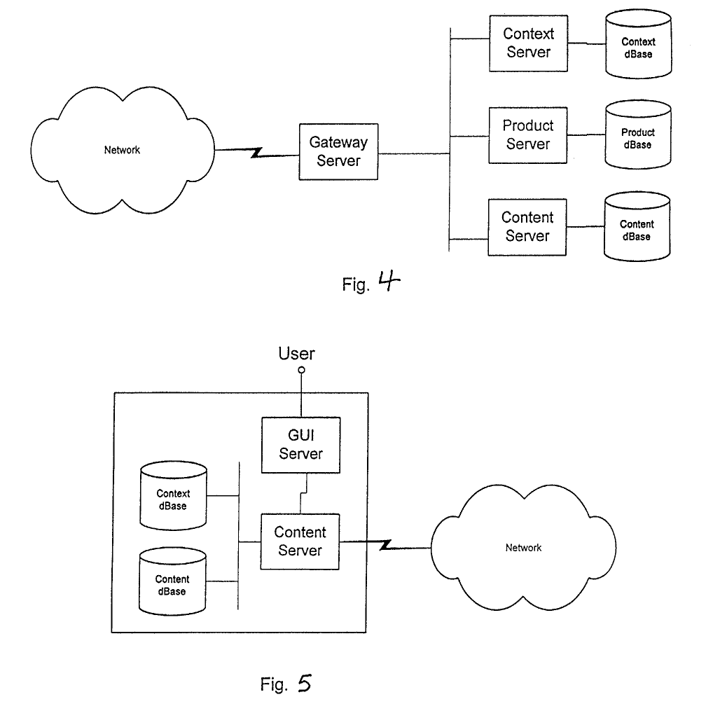

The system employs a server 111 for storing and transmitting the content to the terminals, as well as for programming the GUI. The server has access to, and retrieves data from, a User Profile database and a Geographic Location Profile database, as well as databases containing goods, services, and information. It will be clear to one skilled in the art that these databases may be contained in separate physical databases, or distributed across numerous physical databases as shown in FIG. 4. The tasks performed by the server ill may be distributed to multiple servers. Spreading the databases and server tasks across numerous machines provides protection from equipment failure and allows the system to scale to meet growing demands. Similarly, the tasks performed by the terminal 101 may be divided up among multiple databases and servers as shown in FIG. 5.

The server is connected to a local area network, which is connected via a high-speed circuit 109 to the public networks such as the Internet. The high-speed circuit 109 allows for remote terminals to communicate with the server using VPN technology, thereby reducing the expense of direct communications connections for each terminal. The use of VPN provides a secure private network between the terminals and the server. Additionally, the Internet may be used to seamlessly transmit information to terminals located around the world. Other methods of establishing a communications circuit 105 between the terminal 101 and the server 111 include land-based plain old telephone service (POTS), or other type of computer communications network such as ISDN, a dedicated T-1 circuit, satellite, ADSL, frame relay, or the like, are possible. These communications circuits may connect directly to the server, or via network switches, routers, gateways, or the like.

### Terminal Context

A terminal database stores information about the terminal being used and is used to form a “Terminal Context”. In one embodiment of the present invention, the terminal database is stored as a cookie on the terminal that communicates with the system. The terminal database contains information about attributes such as whether the terminal has a color screen, a printer, or a microphone. The attributes of the system determine the type of content that is retrieved and how it is communicated to the user. Typically, the content database will contain content suitable for multiple different types of user interfaces in a wide assortment of terminals.

In an alternative embodiment, the terminal database stores context information based on, for example, where the terminal is placed and how previous users of that terminal have behaved. For example, if the terminal is located in a seat back of a tour bus, the bus riders that use the terminal may travel to many different geographic locations, but primarily use the terminal to get travel information. The system can use the Terminal Context to build the graphic user interface (GUI) of the terminal to place priority on travel information retrieval. One way that the system can use the Terminal Context to alter the information presented to the user is to systematically increase or decrease values of certain attributes of the Geographic Location Context being used to build a Session Context which is explained below.

In one embodiment of the present invention, a terminal is treated much like an ordinary user in that the terminal logs into (i.e., identifies itself to) the server 111. The server 111 transmits content via circuit 105 to the terminal 101, which the terminal 101 stores in a local cache. Additionally, the server 111 transmits context data to the terminal, which the terminal 101 stores in a local cache. Caching of data and contexts enables faster delivery of content on the terminal 101. The terminal may update its cache during a user's session or during idle times.

In an alternative embodiment, the terminal is completely self sufficient. All relevant information is resident on the device itself. A local search is then conducted in the databases stored on the terminal for relevant content just as the databases on the server. The information on the self-sufficient terminal can be updated at specific intervals. Alternatively, the information on the self-sufficient terminal can be updated at any time. In this embodiment, functions, such as providing information, are conducted without any communication from the terminal to any other device. However, when the requested content requires it, the terminal can communicate with other devices to answer a user request.

In an alternative embodiment, the terminal contains no special software or hardware, and is merely used for communicating with the server. Such a device may contain no special hardware or software for communicating with the server or the Internet. In this embodiment, any telephone that can dial the server or a device connected to the server can be used. All of the information resides on the server, all processing and selecting of content is conducted on the server, and communicated to the user through the terminal.

In one embodiment of the present invention, when a device is first used to contact the system, the device is queried to determine the type of hardware and software present. Alternatively, attributes of the device are determined from the way in which the device accesses the system. For example, if the device is a cell phone, the system will be accessed by the phone through a regular phone line with voice commands, and therefore, the system can immediately determine that a cell phone is being used, and can fill in the device profile with those attributes common to cell phones. Alternatively, the first time that a device is used to access the system, the user of the device may be prompted by the system to answer questions regarding what type of device they are using and if necessary the hardware and software attributes that are present.

Where possible, the system generates some type of cookie or other file that resides on the terminal to indicate the terminal attribute information. The actual attribute information may be stored on the terminal or in a location accessible to the system, such as a server or storage device. In one embodiment, the server links the terminal to a record containing the terminal's relevant attributes through the use of a unique identification value correlated with the attribute information and with the terminal. In one embodiment of the present invention, when a terminal does not have the ability to store attribute information, default attributes will be used depending on the way the terminal accesses the system, and any terminal attributes determinable from querying the terminal itself.

### Geographic Location Context

A Geographic Location Context contains information about geographic locations. The Geographic Location Context is created by system administrators through the creation of a geographic location profile database. For selecting and sending electronic postcards, products, services, etc., the Geographic Location Context includes values for both “Source” location and “Destination” location. For selecting travel information, the Geographic Location Context includes a value for a “Source” location, but not a “Destination” location, unless a user goes on to make a purchase decision based on the travel information he or she receives.

As discussed further below, the geographic location profile database describes various attributes of each location and rates them on a scale for comparison with a user profile as described below and content attributes. The Geographic Location Context may be dynamically updated or static. A dynamically updated Geographic Location Context can incorporate rapidly changing events such as weather conditions and accidents. In one embodiment of the present invention, a terminal is set to a default Geographic Location Context. The setting may take the form of a cookie placed on the terminal to set the system to the default Geographic Location Context. The geographic context can also be modified by what user's of the system are concerned with there.

Regardless of the form that the terminal takes, the terminal is programmed to generate a Session Context and communicate content as a function of the Terminal Context and the Geographic Location Context. When a user who is not previously known to the system (i.e., a non-member user) begins a session, the terminal will communicate content that correlates to the Terminal Context and a default “Source” geographic location. For example, If the terminal is located in wine country, the bulk of the content may be wine based goods or services, and local gift shops, as a function of the Geographic Location Context.

### User Context

A User Context is created from user information stored in a user profile database. User Context information is updated each time a user conducts a personalized session with a terminal. Like the geographic location profile database, the user profile database describes various attributes of each user and rates them on a scale for comparison with the Geographic Location Context, and attributes of content. In one embodiment, the user is given the option of making some of the elements of their User Context available to the public, while keeping other attributes private. By making some of the attributes public, when a user is purchasing a gift for someone, the system is better able to determine what types of gifts would be suitable to both the person giving the gift and the person receiving it.

In one embodiment of the present invention, a user is prompted by the system to log into an existing user profile or open a new user profile database and become a member. If the user elects to open a new user profile and become a member, the user is prompted to answer a series of questions to establish the values of some attributes.

The system sends a first account information screen to the user. The first account information screen prompts the user to enter relevant personal information, a username and a password. The relevant personal information includes the name, address, and telephone number of the user.

After the system receives the relevant personal information from the user, the system sends a second account information screen to the user. The second account information screen prompts the user to enter credit information. In one embodiment of the invention, the user can later automatically pay any fees related to shopping or e-postcards by entering their username and password. Alternatively, the user can pay by credit or debit card at the time of purchase by using a card reader or manually entering the credit information at that time.

Once the user profile has been opened, the system constantly augments the member's user profile by analyzing the actions of the user to refine the values already entered and to assign values to more specific attributes. For example, the initial questions may ask whether the user likes to drink wine. However, at this point there is no information on what type of wine the user likes to drink. Based upon the user's purchase of a large quantity of California Chardonnay, the User's Context is updated to reflect that the user likes white wine, that the user likes Chardonnay, and that the user likes California wines. Further, based on some of the values entered, the system can make educated guesses about other attributes of the user.

If the user does not login and does not elect to open a new profile, then the system generates content based upon a default user profile. The system builds a temporary user profile for the user based upon the user's behavior in the session. The user is given the option of logging in at any time and saving the temporary user profile information to an existing user profile or to a new user profile.

In one embodiment of the present invention, as seen below, the User Context used can be 1) the user's profile; 2) a recipient's profile, if the user is sending something to a recipient; and 3) a group profile, if the user is sending something to a group of people. All three profiles can be created by the user, although the recipient's profile can be created independently by the recipient, with access to certain elements of the recipient's profile allowed to the user. The default profile for the User Context is the user's profile. In another embodiment, the user can select from an array of generic recipient profiles such as men, women, family members, corporate gift recipients, etc.

### Request Information

In one embodiment of the present invention, the user is prompted to select from a series of menu options to determine the data content delivered. Once the user selects a Geographic Location Context (i.e., a “Source” and a “Destination”) , the user is prompted to select additional options to further clarify their request from the system. This additional request information is used to select content for the user.

In an additional embodiment of the present invention, a user is prompted to type in a request. The system parses the text of the question asked by a user for selected words and phrases to help select content in response to that question. For example, if someone asks for information on a five star hotel in London, the system knows to override the User Context information that indicates that the user is a very thrifty individual. The system also knows that the relevant “Source” geographic location value is now London.

### Content Attributes

Content databases store information about goods, services and information that is available for users. The content database is structured to correlate to specific attributes in both the Geographic Location and User Contexts. Thus, a kilt will correlate to both Scotland and men's clothing. The content database is also structured to correlate with attributes of a user's request for content, for example, jigsaw puzzles for children nine years old and under, will not be selected in response to a user request for a birthday gift for their sixteen year old son.

The content area on the server comprises a database containing products and information from multiple “Source” geographic locations. For example, the database is constructed using Microsoft Access Oracle, or Microsoft FoxPro. The database comprises multiple fields including a product identification number, description, vendor, price, geographic location of origin, geographic location of vendor, shipping information, and product category. Additionally, the database may comprise additional fields for each good and service so that goods and services can be filtered based upon the geographic relationship of an associated “Source” location to the receiver's “Destination” location. In an alternative embodiment, the product identification number is created to reflect product information such as the country of origin, the country of intended destination and information about the good or service, such as the ages that it is suitable for.

### Session Context

When the Terminal Context, and one or more of the Geographic Location Context, User Context, and user request are merged they become the Session Context for selecting content. Additionally, the Session Context may be dynamically modified during the session. Only content that satisfies the Session Context, however, is communicated to the user. If the user does not like wine, for example, those pages will not initially be shown because the User's Context, when merged with the Geographic Location Context into the Session Context will not correlate wine with the session. Unless, however, a user's request indicates that the user is requesting wine, in which case wine will be correlated with the session. During the session, the user's navigation pattern may be used to update the User's Context by updating the user's profile database. The updated User Context is then merged with the Terminal Context, the Geographic Location Context, and any user request to create a new Session Context. Content is then displayed which correlates with the new Session Context. The user's navigation patterns may be stored on the local terminal for future use, and may also be transmitted to the server for updating Geographic Context, User Context, and analysis, and also transmitted and cached on other remote terminals.

### Profile Databases

### Building a Tree

The first step in selecting content to display is to create a well defined hierarchical addressing/cataloging scheme. The hierarchical scheme may be thought of as a tree, and is referred to simply as a tree. The larger branches of the tree define very general categories, the smaller the branches become, the more specific the categories. The identifiable locations on the tree are referred to as nodes, and each node is assigned a unique address. For example, a very simplified version of a tree is:

| | |
|---|---|
| 1. | sports |
| | 1.1 hockey |
| | 1.2 soccer |
| | 1.3 NFL |
| 2. | travel |
| | 2.1 USA |
| | 2.1.1 California |
| | 2.1.1.2 Los Angeles |
| | 2.1.1.2.1 Hollywood |
| | 2.1.1.2.2 Santa Monica beach |
| | 2.1.1.3 Napa Valley |
| | 2.2 Europe |
| | 2.2.1 UK |
| | 2.2.2 France |
| 3. | food |
| | 3.1 wine |
| | 3.1.1 red |
| | 3.1.2 white |
| | 3.2 beer |
| | 3.2.1 micro-brew |
| | 3.2.2 commercial |
| | 3.2.2.1 Bud |
| | 3.2.2.2 Coors |
| | 3.3 caviar |
| | 3.3.1 Russian |
| | 3.3.2 Finnish |
| | 3.4 candy |
| | 3.4.1 candy bars |
| | 3.4.1.1 Hershey |
| | 3.4.1.2 almond joy |
| | 3.4.2 chocolates |
| | 3.4.3 ice cream |

In the above example of a tree, the larger branches of the tree define very general categories such as sports, travel, food, etc. The smaller branches detail more specific details. For example, for the general category food, more specific categories include wine, beer, caviar, and candy. More specific for candy is candy bars, chocolates and ice cream. The identifiable locations on the tree are referred to as nodes. For the above tree example the nodes would include sports, hockey, travel, California, Los Angeles, Hollywood, Santa Monica beach, and Bud, to name a few.

As can be seen, each node is assigned a unique address, for example some of the node numbers for the above sample tree include:

1 is assigned to sports,
1.1 is assigned to hockey
2.1.1.2.1 is assigned to travel.California.Los Angeles.Hollywood
2.1.1.2.2 is assigned, travel.California.Los Angeles.Santa Monica Beach
3.2.2.1. is assigned food.beer.commercial.Bud

Of course, additional nodes and branches may exist on a larger tree, and as the tree grows or shrinks, nodes may be added or removed.

### Creating Geographic Location Context In A Hierarchy Tree

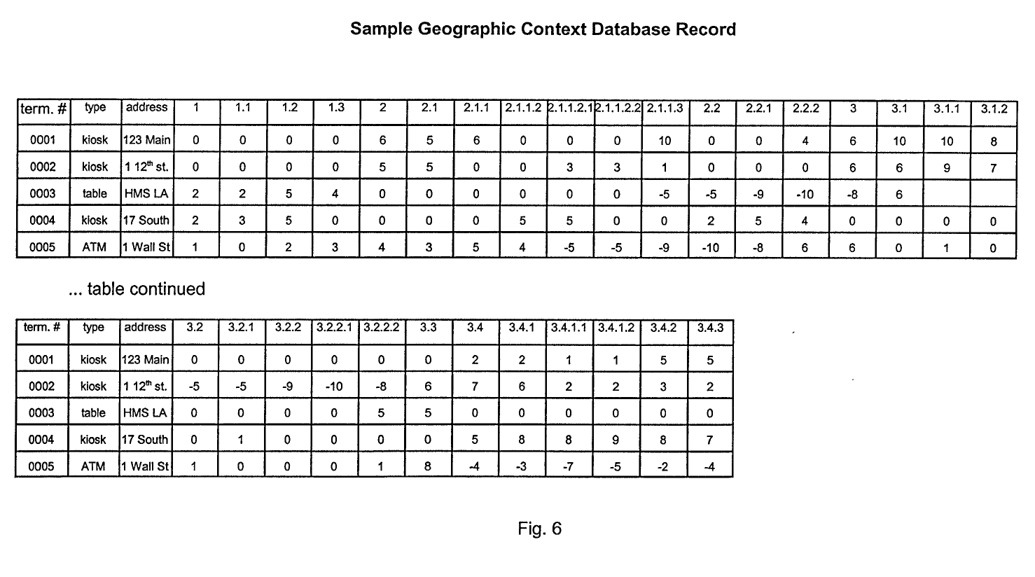

Once a tree is defined, a Geographic Location Context may be created. As discussed above, the Geographic Location Context includes a “Source” location field and a “Destination” location field. A Geographic Location Context is stored as a record in the geographic location profile database. A sample Geographic Location Context is shown in FIG. 6. In the Geographic Location Context, each tree node is scored from −10 to 10, the lower the number, the less correlative the geographic location is with the node, the higher the number the more correlative. In another embodiment, the scoring number values may be larger than 10 to provide more precision or smaller than 10 to provide less precision. In yet another embodiment, the number values are binary to indicate that a geographic location either has or does not have a particular attribute.

Consider the following example of a sample geographic location in FIG. 6: a terminal is located at 123 Main Street in Napa Valley, Calif., (N.B. Napa Valley is known the world over for wine). The Geographic Location Context that the terminal is linked to would reflect a correlation with wine by scoring various tree nodes, such as food (tree node 3-value 6), and especially wine (tree node 3.1-value 10), with higher numbers. Additionally, the terminal may have correlations with other tree nodes, such as travel/US/California/Napa (tree node 2.1.1.3-value 6), and food/beer/micro-brew (tree node 3.2.1). Further, depending on where the terminal is located, the score for food/wine/red (tree node 3.1.1-value 10) may be higher than for food/wine/white (tree node 3.1.2-value 8). Each Geographic Location Context contains segments of the tree that communicate information about attributes of that geographic location and values indicating the correlative strength or weakness of each attribute. If a geographic location's correlation to a tree node is unknown, the value of the node may be set to zero.

### Creating User Contexts In A Hierarchy Tree

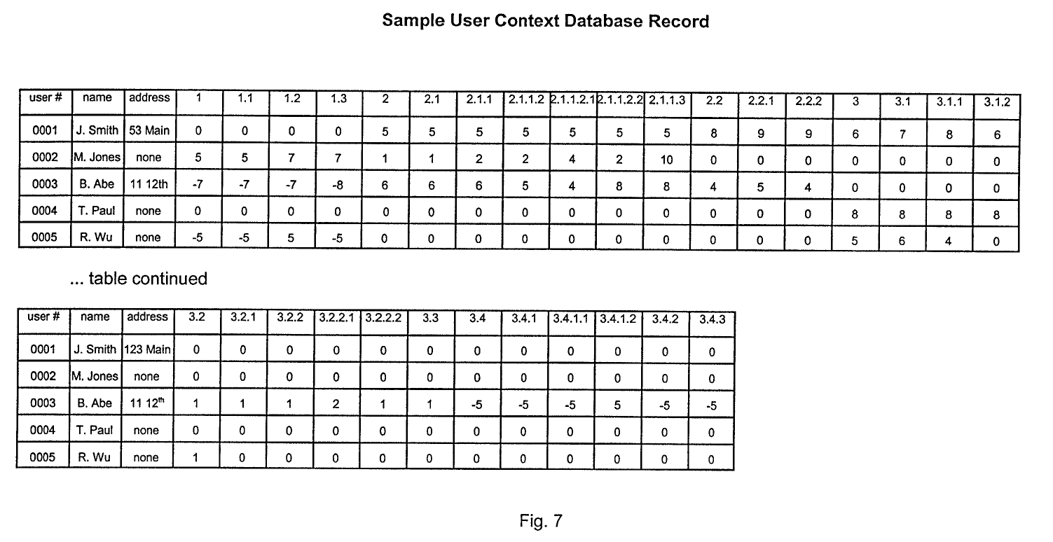

User Contexts are also used by the system much like a Geographic Location Context. A User Context is structured like a Geographic Location Context, except that User Context may have additional fields of data in the User Context record to retain additional information that are not applicable to geographic locations (e.g., credit card information, a phonebook of contacts including e-mail addresses, etc.). Each User Context is stored as a record in the user profile database. A sample User Context is shown in FIG. 7.

Like a Geographic Location Context, a User Context associates which nodes of the tree are correlative with the user, and tracks other user related information. Put another way, the user's profile shows which tree nodes are in common with the attributes of the user. In the user's profile, each tree node is scored from −10 to 10. The lower the number the less correlative the user is with the node, the higher the number the more correlative. In another embodiment, the number values of scoring may be larger than 10 to provide more precision or smaller than 10 to provide less precision. Further, the values may be binary to show that a user either likes or dislikes a particular thing.

When a new user uses a terminal, the system may request the user to identify himself or herself so as to create a User Context. In one embodiment, users input a user name and/or password, and then provide information such as their home address, e-mail, likes and dislikes, etc. In another embodiment, users may use their credit card or other identification card to authenticate themselves with the systems. User's may, in another embodiment, update some or all of the information stored in their user profile record. For example, a user may wish to input address contact information to facilitate sending electronic postcards, or even to express a particular interest or dislike in a tree node (e.g., “I love micro-brewed beer”). The system may facilitate users' updating their user record directly from a terminal, or from the Internet using a standard web browser tool such as Netscape's Navigator.

In an additional embodiment of the present invention, the system provides the user with the opportunity to create or modify their User Context by importing data from accounting software such as Quicken, or Microsoft Money. Furthermore, a user can import their credit card spending history by either providing a file or authorizing the system to contact a credit card company and acquire 30 purchasing history for a set period of time. The user can also authorize the system to contact one or more supermarket club databases so that the system can acquire detailed purchasing information. The importing of data allows the system to create an elaborate user profile without asking the user a lot of questions.

In one embodiment of the present invention, the system sends a cookie through the user's Internet browser to the user's terminal. The cookie allows the server to automatically identify information about the user when the user next visits the server using the same terminal.

### Creating Session Context

Next, the system uses the data contained in the Terminal Context and one or more of the Geographic Location Context, User Context and a user request to generate a default Session Context. Session Contexts are used by the system to select the content to display. Session Contexts are created for each session and may be generated in advance and cached by the system or generated in real time during the session. Generally, the Session Context is generated by the remote terminal 101, however, in another embodiment, the Session Context may be remotely generated by the context server, another terminal or server and transmitted to the remote terminal 101. Another embodiment uses static Session Contexts which are generated and reused by the terminal. Session Context generation may also be enabled and disabled as desired using the default Geographic Location Context as the Session Context.

The system creates the Session Context by combining additional weighted information with the Terminal Context, the Geographic Location Context, and the User Context, thereby modifying the scores assigned to the various tree nodes. The combining functions include the full range of mathematical operations and functions such as addition and subtraction, absolute value, exponential operations, algebra and calculus. For example, the system may be programmed to generate a Session Context which more heavily scores a particular tree node by a given value (e.g., add a value “x” to the Terminal Context node abc) . The Session Context now increases the likelihood of content selection for the abc node. Similarly, the system may also decrease the likelihood of content selection by subtracting value.

In generating Session Contexts, any or all of the Geographic Location Context's tree node scores may be modified, thereby augmenting the session. Session Context node scores may be slightly modified or may be modified significantly from the Geographic Location Context node scores. For example, if a major hurricane is forecast to make land fall near the terminal's location, the system may generate a context which reduces all node scores to their minimum (e.g., −10) and increases the score for local weather to its maximum (e.g., 10). Accordingly, the system will now display local weather content which will be of strong interest to users.

In generating the Session Context, the system is also programmed to make inferences and assumptions based on the geographic location, and from other external information which is either obtained or known. Information about the terminal's physical surroundings, such as the weather, the climate, or even a current event that is likely to impact users may be used to generate a highly correlative Session Context. For example, a person interested in wine may be more likely to go the theater than a person who drinks beer or a person interested in sports. Therefore, a geographic location with a high correlation to wine may be scored higher for theater even though the geographic location is not known for theater. This is because it can be assumed that the typical visitor to the geographic location would want to know about the theater. If on the other hand, this assumption is proven wrong because no visitors to the geographic location request theater information then over time the Geographic Location Context is modified to lower the value assigned to the theater attribute.

Another example is the nearest neighbor assumption. When making a nearest neighbor assumption, the system assumes that a geographic location scored for a particular node may be similarly scored for a node which is closely related. For example, if a geographic location is scored high for Bud beer, in generating the Session Context the system may assume a similar score for Coors. Additionally, the system may assume a similar score for beer, although this assumption may not be as accurate as that for Coors beer.

It is important to note that the system will generate a Session Context from a Geographic Location Context without a User Context. Put another way, the user need not identify himself or herself and create a User Context for the system to generate a Session Context and display content. If a new user operates a terminal, the system may simply create a Session Context as described above (without considering a User Context, e.g., the system selects a default “Source” geographic location). In one embodiment of the present invention, if a user is not logged in as a member and has not elected to create a new user profile, the system stores the user profile information gleaned from the user's actions in the present session in a temporary user profile. The user is given the option of logging into an existing account or creating a new account and incorporating the information stored in the temporary user profile.

In an alternative embodiment, the system may require that users create a user name so the system may begin to build a User Context. If a User Context is available (e.g., the user has been authenticated with the system), then the system may be programmed to consider this additional information in creating a Session Context. A user is given the option of changing the Geographic Location Context (by changing either the “Source” location or the “Destination” location) to another location at any time to simulate a traveling and shopping experience. By allowing the user to change the Geographic Location Context, the system is not only facilitating shopping for geographically distinctive gifts, but also creating an impulse buying mood.

When a user changes the geographic context in the middle of a session, the user context, terminal context, and any user request information remains the same. Therefore, if a user is looking to purchase tee shirts in, for example, Paris, France, if the user switches the geographic context to Rome, Italy, the Session Context will lead the system to present the user with tee shirts from Rome, Italy.

The method of creating Session Contexts which incorporates data from the User Context is identical to creating Session Contexts from a Geographic Location Context described above. Inferences and assumptions may also be made about users much like it is with geographic locations. The system may be programmed to consider the User's Context as well as the Geographic Location Context or to consider only one or the other. Further, when considering both the Geographic Location Context and the User Context, the system may be programmed to give one or the other more weight or to consider them equally. In an embodiment, the values of each context for each node in common are added together and divided by the number of contexts with the node in common to acquire a new value for the common node.

Additionally, the system may be programmed to give one or the other more weight as a function of an external factor or an inference or assumption made about either the Geographic Location Context or the Session Context. If the user has made a specific request of the system, then the system may be programmed to consider this additional information in creating a Session Context.

The method of creating Session Contexts responsive to a user request involves comparing particular elements of the user's request to the attributes of the content as well as altering the Geographic Location Context and User Context in response to the user's request. For example, the user will select a menu option to purchase a gift. The system may then prompt the user to select a receiver of the gift from a menu of categories and/or individuals.

Once the user makes a selection, the system can incorporate any available recipient profile information of the gift recipient as well as the User Context of the user. If no recipient information is available for the gift recipient, the system can prompt the user for information about the recipient such as the age and the sex of the recipient and whether an occasion or price limitation exists. The system then prompts the user to establish a Geographic Location Context by selecting a “Source” geographic location value from which to select the gift, and a “Destination” value to which to send it.

For example, the user may be prompted to select a gift from the current “Source” geographic location being used, or to choose another “Source” geographic location. Once the proper Geographic Location Context has been determined, the system then sorts through all of the items from the relevant “Source” geographic location that can be sent to the “Destination” location, and that are appropriate for the recipient in terms of the specified attribute, e.g. prices, sex, occasion, etc. In an additional embodiment, the gift is further selected based on the recipient's known preferences, or with regard to any information about the recipient indicated on the user request.

In an alternative embodiment, the user can enter a request for a birthday gift from Tokyo, Japan for their 5 year son in Mexico City as a single question, and the system will parse the question to determine the relevant information. Thus, the system will set the “Source” geographic location value to Tokyo, Japan, and the “Destination” geographic location value to Mexico City, Mexico, and will select items for the user that are appropriate as gifts for a 5 year old boy. Depending on the type of gifts selected by the user, the next time that the user attempts to purchase a gift for their 5 year old son, either from the same geographic location or from a different geographic location, the system uses the previous purchase to create session context in selecting new products to present to the user.

In an additional embodiment, a user can request that the system display advertisements targeted to them. In one embodiment, advertisements are considered to be content and are categorized with attributes like other content. The request for targeted advertisements can be made either in a user profile, so that the request is automatically incorporated when a user logs into the system, or the request for targeted advertisements may be made during the session at any time by either a member or a non-member. In an alternative embodiment of the present invention, advertisements are automatically displayed for the user.

In one embodiment, the Session Context can be either passive or interactive, either of which will alter the content displayed. A passive personalized session displays content that matches the Terminal Context, default Geographic Location Context, and a default User Context without input from the user. A personalized session becomes interactive in three ways; (1) when the user specifies a “Source” geographic location value other than the default “Source” geographic location value (the physical location from which the user is connecting to the server); (2) when the user specifies a person (or group) “User Context” by activating a user profile or creating a new profile; and (3) when the user requests specific content such as that relating to a particular occasion or product type.

### Selecting Content

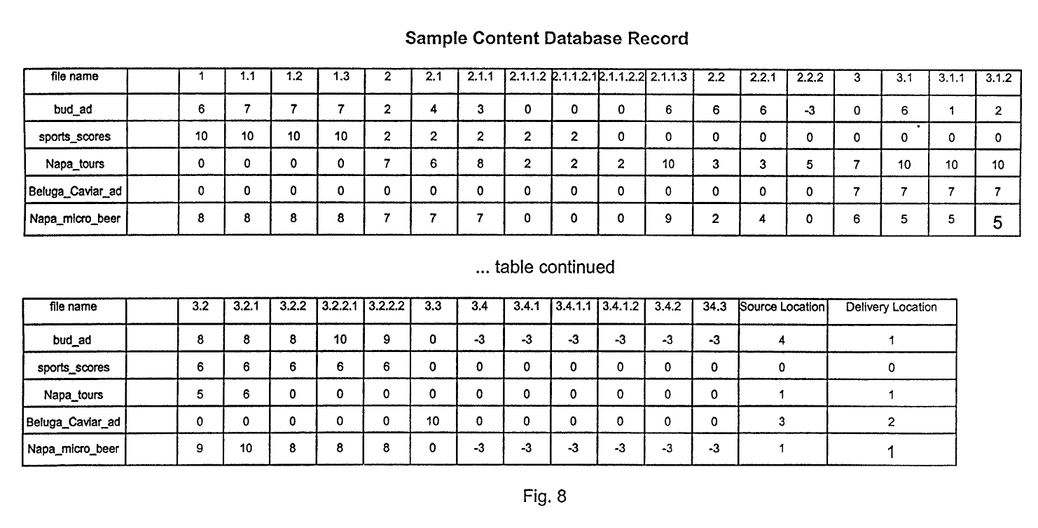

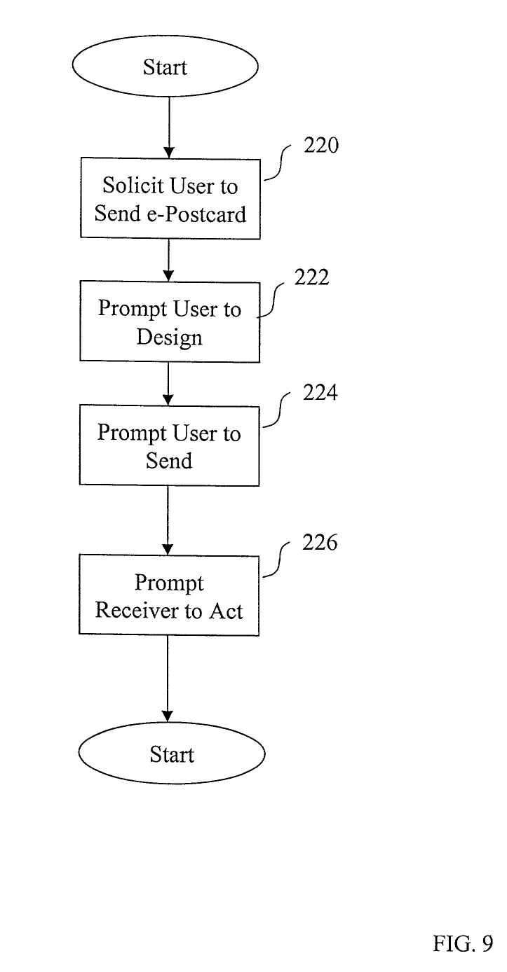

Each piece of content is entered into the system as a content database record. A sample content database record is shown in FIG. 8.

The content database record stores each piece of content's node scores (e.g., −10 to 10). The node scores show the correlation of the content with each tree node. As with User and Terminal Context node scores, each piece of content will likely have a correlation with more than a single node of the tree. For example, Budweiser will likely be scored a 10 for tree node 3.2.2.1 (the node assigned to food.beer.commercial.Bud). However, Budweiser may also be scored an 8 for tree node 3.2.2 (the node assigned to food.beer.commercial). Additionally, Budweiser may be scored in other categories such as travel. USA. Missure. St. Louis (not shown on the sample tree), etc. Furthermore, items can be scored to correlate with age, sex, or occasion.

In an embodiment of the present invention, each content profile contains information that allows the content to be selected to avoid duty or import restrictions associated with purchasing and/or receiving that content in a particular location, known as “Duty Included Shipping.” For example, in one embodiment of the present invention, in order to avoid duty and to avoid import restrictions, the choice of goods shown to a user will be filtered based on duty and import restriction information. The advantages to “Duty Included Shopping” include: (1) no waiting in customs lines; (2) no extra charges, and no confusing calculations of duty; (3) a streamlined session for purchasing international goods; (4) every item that is displayed can be sent to the specified destination (or pre-specified, in a user profile) without paying additional duty; and (5) because items will not be shipped as far, the items will arrive quicker.

For example, in one embodiment, only items that are already imported into the recipient's country (“Destination” geographic location) will be made available to the purchaser. The system selects and displays only those products within any country or region that match (1) the user's preferences in the user's profile; and (2) are available through vendors who sell products in the user's country without duty. The user establishes the “Destination” geographic location value for themselves or a recipient when prompted to answer the following question: “To which city do you intend to a send a product/gift item?” Once the answer to this question has been received, the country of the destination is a geographic restriction is used in selecting the items shown to the user for purchase.

Therefore, every product is assigned two or more fields with regard to geographic location. First, the item is assigned information explaining where the item is from (a “Source“geographic location value); and second, each item contains information about where the item can be sent to without duties or import restrictions (a “Destination” geographic location value). Additionally, each item may have information about where the item is currently, i.e, vendor information (or manufacturer information in the case of made-to-order products). In an embodiment, once the user or the system establishes the Geographic Location Context (the combination of “Source” geographic location and “Destination” geographic location values) the system selects a corresponding pre-sorted database of products from the “Source” geographic location that can be sent without duty restrictions to the “Destination” geographic location of the recipient by the appropriate vendor or manufacturer.

In one embodiment of the present invention, the same item has separate records depending upon where the item is from (“Source” geographic location) and where it can be sent (“Destination” geographic location). For a gift item to be displayed, the place where the item can be sent should match with a “Destination” geographic location of a recipient as specified by a user or in a recipient's profile. The default recipient is the user, so the default “Destination” geographic location is the country in which the user resides, as contained within the profile. Likewise, if a recipient is identified as a member, the default “Destination” geographic location country for a recipient is contained in the recipient's user profile. Additionally, the user can specify different “Destination” locations during their purchase by answering the above question with a “Destination” location other than the default “Destination” location.

In an alternative embodiment of the present invention, the same product may be manufactured in multiple locations. For example, a tee-shirt about Rome, Italy (Rome, Italy is the “Source”) may be manufactured in the United States, Italy, France, and Japan (thus, any of those countries are possible duty free “Destinations”). If the intended recipient is in the United States, the system will select the tee-shirt about Rome (“Source”) that is manufactured in the United States (“Destination”).

In an embodiment, each content element, including a good or service is assigned a stock keeping unit (“SKU”). A product assigned with a “Source” geographic location is given a different SKU for each different shipping “Destination” location. In one embodiment, every combination of “Source” and “Destination” is given a unique SKU. Before an item is analyzed for the sake of comparison with the User Context, the list of content items for comparison is limited using the “Source” and “Destination” of the content. By limiting the content elements for comparison with the User Context, the search is made more efficient.

The SKU may also have other filtering parameters built into it, such as the type of product, the price range, priority, and popularity. In an additional embodiment, the content items may be further limited based on particular elements of the user's request such as the price range.

When the system selects content from the content that has been pre-sorted by “Source” location and “Destination” location, it may choose the content which is the most correlative with a given node. Alternatively, the system may compare each and every node in common between the User Context and the Geographic Context by subtracting the values assigned at each common node from each other to obtain a comparison value; adding up all of the comparison values, and choose the content element leading to the lowest total.

Additionally, if a piece of content has already been displayed during a session, the system may be programmed to display the next most correlative piece, etc, or to rotate those pieces of content which have the same correlation. The system may employ additional programming so as not to display two pieces of content from the same category (i.e. Bud and Coors) during the same session, or at the same time.

In one embodiment of the present invention, the system utilizes the Terminal Context, the User Context, the relevant Geographic Location Context, and a user request to choose the most appropriate content. In an additional embodiment, the system uses multiple User Contexts to provide content. For example, if a user wishes to purchase a gift for someone else, the user can create a user profile for the recipient. Alternatively, if a publicly available user profile for the recipient exists, the system can automatically incorporate the attributes of the gift recipient into the decision making process. In this manner the system chooses a gift from a particular geographic location that conforms to the attributes of the sender, for example it is within a given price range, and it is a home decoration. The system will also choose a home decoration within the price range of the sender that fits the attributes of the gift recipient, for example, something that will not affect the recipient's allergies, or that is not in a color that the recipient does not like.

In an additional embodiment of the present invention, a person can send a gift to multiple recipients at once. The system analyzes any recipient profiles available to determine common attributes among the gift recipients. Once common attributes are identified, the system selects one or more gifts from a list of products selected based upon “Source” geographic location and “Destination” geographic location, that would satisfy each member of the group based on correlation with the one or more common attributes. Alternatively, a user creates a group profile and describes various attributes that the group profile has. The system then uses the group profile as the system uses an individual User Context to select content to be sent from a user to the members of the group.

### An Electronic Assistant

For the sake of illustration, various user requests will now be discussed with reference to an embodiment in which the system functions as an electronic assistant. A user may request many different types of content in an electronic assistant. For example, even the choice of a user to log-in is a request to automatically personalize the content for the user by merging the User Context with the Geographic Location Context and Terminal Context. Therefore, logging-in by a user creates a default Session Context using available User Context, Geographic Context and Terminal Context. At all times during the session the Electronic Assistant offers the member the opportunity to further customize the Session Context by requesting specific things. This is accomplished by making a selection from a series of menus. The same choices are available to non-members at all times during their sessions.

In one example embodiment of the Electronic Assistant, there are eight basic requests that can be created by the user. The first type of request is for specific product recommendations for the user himself. These requests ask the Electronic Assistant for personal product recommendations within a specific price range, retail category, those offered by a specific vendor, etc. For members, this request alters the session context by overriding product selection based on the attributes of User Context. This works by filtering based on “Source” location, “Destination” location and other request elements and then selecting based on User Context.

The second type of request a user can make is for a wide range of customized travel recommendations regarding hotels, restaurants and itinerary. These requests change the Session Context by asking the Electronic Assistant for more specific travel recommendations than those selected based on the User Context. For example, the user will select a particular price range for a restaurant or hotel from a menu. Alternatively, the user will specify the length of stay on a particular trip, which will alter the itinerary offered by the Electronic Assistant in the automatic mode. Again, for members, creating this specific request changes the Session Context from a Session Context based on the user context. This also changes the User Context so that future Session Contexts will take into account that the user is interested in the type of content that they are currently requesting.

The third type of content that a user can request is a customized travel book. The travel book includes hotel, restaurant, and site information selected based upon Geographic Location Context, User Context, Terminal Context and any specific user requests. The travel book may contain third party content, such as maps or restaurant and hotel evaluations. The system may tabulate a list of the third party content incorporated, so that the third parties may be compensated for the use of their product. The Personalized Geographic Shopping System can be hotlinked to the information in the travel book.

The fourth type of content that a user can request is a customized travel magazine. The travel magazine includes articles, hotel, restaurant, and site information selected based upon Geographic Location Context, User Context, Terminal Context and any specific user requests. The travel magazine may contain third party content, such as maps or restaurant and hotel evaluations. The system may tabulate a list of the third party content incorporated, so that the third parties may be compensated for the use of their product. Furthermore, the travel magazine may contain advertisements with hotlinks for products from geographically relevant vendors represented in the Personalized Geographic Shopping System.

The fifth type of request a user can make is for gift/postcard suggestions for another person or group. These requests change the Session Context to a gift buying session by utilizing the recipient's user profile in addition the current user's (sender) user profile. The sixth type of request a user can make is for gift/postcard suggestions based on a particular occasion or event. The seventh type of request a user can make is to retain the Session Context as much as possible, while changing the Geographic Context within a given session. When the user wishes to change to another geographic location, the set of criteria already established by the user in terms of price, type of content, etc., may remain constant while the geographic location changes.

The eighth type of request that may be made by a user is for Personalized Tourism Information. If the system receives a selection by the user to acquire tourism related information, the user terminal opens up an Internet browser. The Internet browser is directed to virtual tour information for the location of the user terminal. The information for the virtual tour resides either on the postcard server or is stored locally on the user terminal itself. The virtual tour information includes location and other specific information about popular tourist destinations including museums, hotels, and other points of interest.

If the system receives a selection by the user to acquire tourism directions to a tourist landmark, such as a museum or a hotel, the user terminal opens up an Internet browser. The Internet Browser is directed to a screen generated by the system that displays landmarks located in the geographic area surrounding the specific user terminal. The system prompts the user to choose a landmark that they are trying to get directions to.

In one embodiment of the present invention, once the system receives a landmark selection, the system contacts a third party direction provider, such as Mapquest.com. Once the third party direction provider has been contacted, the system submits a query for directions and transmits the location information of the terminal as the starting point and the landmark information as the destination point. Once the third party direction provider returns the direction information, that information is displayed for the user.

In a preferred embodiment of the present invention the terminal also comprises a printer, so that a user can choose to print out the directions. Alternatively, the directions from the terminal to each of the landmarks are stored in a database on at least one of the server and the terminal. Once the user selects a landmark a database query is run, and the directions are displayed.

### Electronic Post-Cards

In an embodiment, of the present invention, shown in FIG. 2, the system solicits a user to send an e-postcard to a recipient 220. The user is prompted to design the postcard 222. The postcard is sent to a recipient 224. In one embodiment, the e-postcard is sent as an e-mail to a recipient that is readable using a traditional e-mail reader such as Netscape or Yahoo!. Alternatively, the e-postcard is displayed in a pop-up Internet browser window, so that the e-postcard appears without all of the navigation buttons and tools of a traditional Internet browser or e-mail reader and more like a traditional postcard. The receiver is prompted to act on the e-postcard 226. The user may act on the postcard by, for example, clicking on an area of the postcard, and using their Internet browser to communicate with the server to acquire more geographic and tourism information, to shop, or to send an e-postcard to another recipient.

In an alternative embodiment, the receiver does not comprise any kind of device. The e-postcard is printed out and is sent to a receiver through traditional mail. In one embodiment, the user is prompted to print the postcard out at the terminal, and post it themselves. In one embodiment, the postcard that is printed at the terminal is printed with the receiver's address on it. In another embodiment, the postcard that is printed at the terminal is printed with the receiver's address and precalculated location specific postage printed on it. In an alternative embodiment, the postcard is printed at a centralized printing location other than the terminal and mailed to the recipient by someone other than the user. Preferably, the postcard is printed and mailed from the closest location possible to the receiver to minimize the postage costs. The printed postcard includes the website address of the postcard server website so that a user can go to an Internet linked device and go to the postcard server website.

If the system receives a response from the user indicating that the user wishes to send an e-postcard, the system opens a file for the e-postcard on the postcard server. In the file on the postcard server is the content and formatting information for the e-postcard. The system displays a postcard type screen. The postcard type screen prompts the user to choose either an e-postcard sent to a user's Internet linked device, or a traditional postcard that is printed and mailed to a recipient through traditional mail.

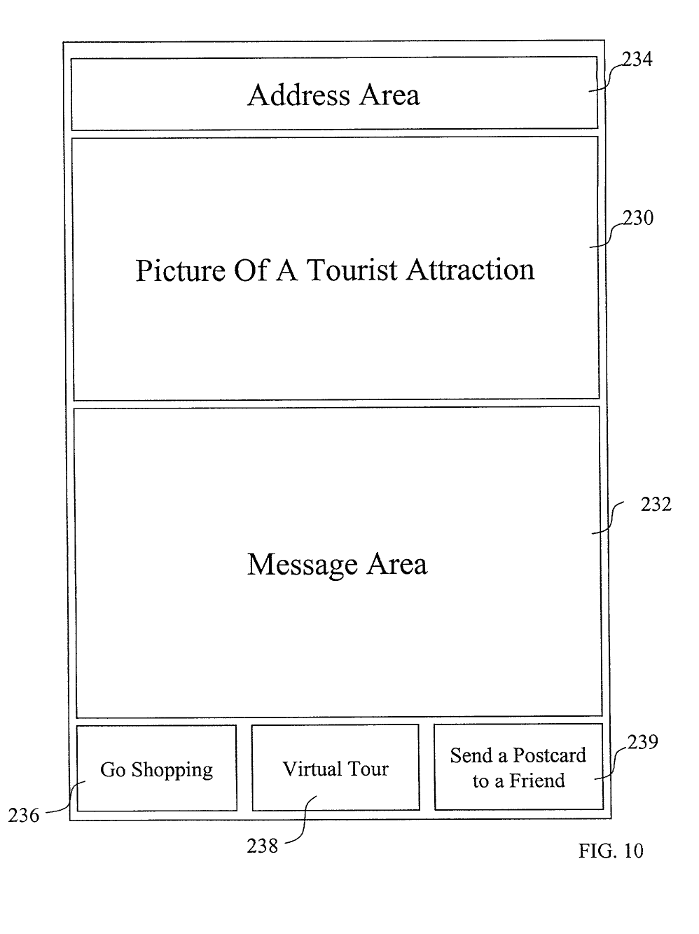

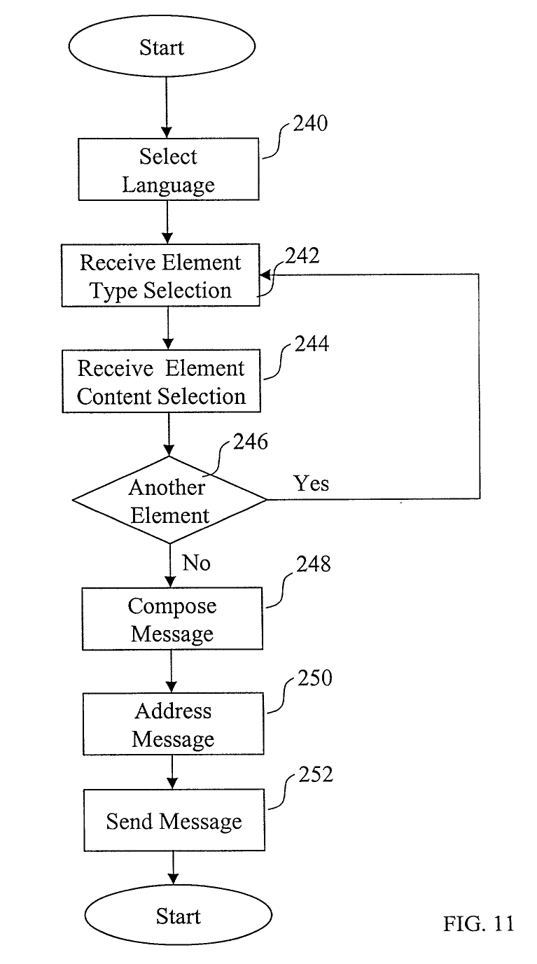

In one possible embodiment of the present invention, as shown in FIG. 10, an e-postcard has three elements. A first element is a single image of a travel destination, a tourist attraction, a monument or artwork that is associated with a specific location 230. For example, the image on a card for Paris may be the Eiffel Tower. As described below the first element may consist of video, many images composited together, or a slideshow, rather than one image. A second element is a place to write a message to the receiver of the e-travel postcard 232. As a third element, the card contains an address area, where the address of the recipient is placed 234.

Once the system receives a postcard type selection, the system displays a first element type screen for the user. The first element type screen prompts the user to select a first element type for their e-postcard. The first element type screen displays different types of content elements for the user to choose from. The content types are shown as graphics or text, or a combination of both. The type of content that the user can choose to insert depends on the type of postcard being sent. For example, the user will not be prompted to choose a video to insert if they chose to send a traditional postcard.

Further, the user may be prompted to select as one possibility a “quick-card” option. Under the “quick-card” option, the system automatically selects some content elements of the card to simplify and expedite the postcard generation process. The “quick-card” option would allow a user to send a postcard with the minimum number of keystrokes, clicks or steps possible. In one embodiment, when the user selects the ” quick-card” option, all of the media content is selected for the user and the user is passed on to the message part of the postcard as discussed below. In an additional embodiment, the media content chosen for the “quick-card” is based on popularity statistics of the media content elements. In an additional embodiment, the media content chosen for the “quick-card” is based on a randomizer that selects media content elements from a content element database randomly to compose the “quick-card.”

In one embodiment, as discussed above, the user may select a single image of a travel destination, a tourist attraction, a monument or artwork that is associated with a specific location. The user may select additional multimedia elements to insert into the e-postcard. The user may insert an animation, a slide show of the local top tourist attractions, 360 degree panorama views, virtual tours, and video clips. The user may insert non-image geographically specific content including recipes, folk stories, poems such as haiku and limericks, sayings, logos, sports statistics, music, local information, and local news. Additionally, the system provides stories told by various members of specific geographic locales as elements. Also, the system provides information about local heroes. The promotion of local heroes creates additional viral marketing and promotional opportunities for local celebrities, and additional content of local interest to send to a recipient.

In an additional embodiment of the present invention, the sending site comprises one or more of a microphone, a digital camera, and a scanner. The user can attach a voice message along with the e-postcard by speaking into the microphone. The user can attach a photo of themselves taken through the digital camera composited onto another picture of a famous background. Once a picture of the user is entered into the system, it can be stored for future use on other postcards and with other backgrounds. The user can scan photos or documents into the scanner and send the generated graphic on their postcards.

Once the system receives a selection of the type of content the user wishes to have as their first element 242, the system generates an element content screen. The element content screen prompts the user to choose the content of the particular element type that the user selected. In an embodiment of the present invention, the system selects the choices for the user from a database. The database is searched by the type of object and the geographic location of the terminal. For example, if the user selected the element type of a still photo, the system displays 20 different pictures of the geographic location in which the terminal is located and prompts the user to choose one of them. In one embodiment, in response to the choice of an element type, the terminal requests content of that type from the postcard server. Alternatively, if the content is often requested or is large and time consuming to acquire over the remote communication link, the content is stored locally on the terminal.

Additionally, the user can attach a gift certificate to the e-postcard. If a user selects the gift certificate as the type of element that they wish to insert, the system prompts the user to insert their credit or debit card to pay for the gift certificate. Once the user inserts their credit card, the system identifies the country of origin and any other pertinent personal information about the user. Alternatively, if the user has an account, the user is prompted to enter their username and password, and to user the credit information in their account to pay for the gift certificate. The system prompts the user for the amount that they wish to place on the gift certificate. Depending on the information obtained in the card, the system prompts the user in the user's native currency to help the user determine how much they want to spend. If the native currency was not determinable from the card, then the system prompts the user in the currency of the location where the sending site is located.

Additionally, the user can shop for an item and send it to someone along with an e-postcard to notify him or her that the purchase is on the way. The e-postcard notification contains the order number information so that the recipient of the e-mail postcard can click on a “check status of order” button on the e-postcard and view the shipping information of the item. Alternatively, a recipient can call over the phone to a customer support system to check on the status of the items they are to receive. In an alternative embodiment, a recipient is provided with a shipper tracking number and they can go to the shipper's site, enter the tracking information, and check on the status of the goods they are to receive. Additionally, if the sender of the gift did not know the shipping address of the e-postcard recipient, the e-postcard prompts the user to enter a shipping address so that the gift can be shipped. Once the address is received, the item is shipped and an e-postcard containing the item's tracking information is sent to the recipient. The user may return to their e-postcard as often as they would like to check on the status of the items being shipped.

Once the system receives a selection of a content element from the user 244, the system inserts information about the element type and the element content into the e-postcard file on the postcard server. This information includes the location of the element content and information necessary for the system to format the content elements correctly. If the element is a multimedia element that is already created, then the element information includes the location of the element on the server. In the case of an audio file being recorded at the terminal, the terminal generates an alphanumeric file name based on the location of the terminal, the date, and the time of recording. The terminal sends the file to a specific location on the postcard server, and appends the location and filename of the audio file to the postcard file on the postcard server.

The system prompts the user to either select another content element type, edit a content element that they already inserted, or compose a message 246. If the user selects the option of adding an additional type of element, and therefore another element, the system displays a second element type screen. Once the user selects a second element type that they would like to insert, the user is again prompted to select content for the element type that they selected. After the user selects the content, the system prompts them to select another element type or compose a message. The system repeats itself, until the user has added all of the content elements that they wish to add and are ready to compose a message to the e-postcard receiver.

Once the system receives a selection from the user that they wish to compose a message to the receiver, the system presents the user with a message window in which they can type a message to recipient. The user is prompted to select from several different fonts for the text of the message. At least one of the fonts is designed to look like handwriting. In one embodiment of the present invention the user uses a traditional keyboard to enter text. In an additional embodiment the system displays a keyboard on the touch screen monitor that the user can type on by pressing the touch screen at the appropriate location. In another embodiment, the sending site comprises an electronic pen and writing tablet, and the user is prompted to hand write text into the message. In an alternative embodiment the user is prompted to composite handwritten text onto other content elements.

In another embodiment, the terminal comprises speech to text recognition software and a microphone. In this embodiment the user speaks the message text into the microphone and the speech to text recognition software processes the speech into message text. In an additional embodiment, the system allows the user to check the spelling of their message. Additionally, the system comprises text to speech software and speakers, and provides the user with the option of having their text read back to them.

Once the system receives the message from the user 248, the system appends the message text to the user's file on the postcard server along with any relevant formatting information. The system generates an address screen that prompts the user to enter an e-mail address if the e-postcard is to be sent electronically, or a physical address if the e-postcard is to be sent through traditional mail. The user is given the option of sending the postcard to more than one person. If the user selects this option, the user is prompted to enter address information for each additional person or entity that they wish to be a recipient.

Additionally, the user is given the option of using an address book stored in a user account on the postcard server to insert the address. This option will be available to users who have already opened up an account on the postcard server. Once the system receives an e-mail address of a recipient 250, the user is prompted to send the message.

In one embodiment of the present invention, the postcard server has a worldwide address database stored on a memory device. The user is given the option of searching the database for the address of the intended recipient. The user is prompted to enter the name and other information of the recipient. Once received the postcard server conducts a query of the database to find any matches. Once the database has been searched and the results obtained the server prompts the user to select one of the people located, conduct another search or enter an address manually.

Alternatively, the user is given the option of using an Internet person locator, such as “theultimates.com” or Yahoo! People Finder, to obtain the address of the recipient. The user is prompted to enter the name and other identification information of the recipient. Once the information has been received the server contacts an Internet person locator through the Internet. The server then passes the identification information to the Internet person locator. The server receives information back from the Internet person locator, and prompts the user to select one of the people located, conduct another search, or enter an address manually.

In an additional embodiment of the present invention, the postcard server tracks previous messages sent by a particular user. The server prompts the user addressing a new postcard to select the address of one of the previous recipients, or to enter a new address.

In one embodiment of the present invention, the user is prompted to send the message at a specific later date, such as on a recipient's birthday. If the user selects this option, the system prompts the user to enter the date that the user wishes the e-postcard to be sent.

Once the user selects that they wish to send the message 252, the postcard sending procedure begins. If a fee is being charged for the e-postcard, the user is prompted to enter their debit or credit card into the card reader before the address and instructions to send the e-postcard are sent. Alternatively, the user is prompted to enter their card number and pertinent credit information onto the screen. Additionally, the user is prompted to enter a user name and password to pay for the e-postcard through the credit card information in their existing account on the postcard server. Once payment is received, the message is encoded and sent to the server, along with the address of the recipient and instructions for the server to generate the e-postcard.

The server generates the code that will form the e-postcard. The server contains perl script, PHP, or other HTML generating code that goes through the e-postcard file and generates an HTML formatted document. The system initially generates HTML to format the multimedia elements of the card. The system inserts HTML tags that instruct the recipient's Internet browser or email reader where to find the multimedia object. Using HTML, the system formats the text of the message for the recipient.

In one embodiment, the system adds a hotlink containing button to the e-postcard prompting the recipient of the e-postcard to go shopping in the geographic location that the e-postcard was sent from. This is shown in FIG. 10, as Box 236. Thus, if the receiver of the e-postcard clicks on the button, an Internet browser window will open and be directed to the postcard server. If the sender has included a gift certificate, the hotlink button will specify the amount of the gift certificate and prompt the receiver to go spend the money.

Whether or not the postcard includes a gift certificate, upon receipt of the postcard, the recipient is invited to begin a geographic shopping session. As discussed above, the recipient's “Source” defaults to the sender's “Source”. That is, the “Source” location of the postcard sender becomes the “Source” location in which the postcard recipient begins their geographic shopping session. The “Destination” for the postcard recipient's geographic shopping session defaults to the “Destination” chosen by the postcard sender. The recipient can go on to change either the “Source” location or the “Destination” location as they please.

Additionally, the system adds a button to the bottom of the postcard prompting the recipient to go on a virtual sightseeing tour of the geographic area from which the e-postcard was sent. This is shown in FIG. 10, as Box 238. The virtual sightseeing tour includes additional slide shows, 360 degree panoramic views, and video clips from the country or region's top tourist attractions. Moreover, the virtual sightseeing tour offers the suggestion to buy geographically distinctive gifts from the geographic area from which the postcard was sent. In one embodiment of the present invention, a hotlink button appears on a recipient's screen during the virtual sightseeing tour prompting the recipient to shop for geographically distinctive gifts from where the e-postcard was sent. As discussed above, the postcard sender's choice of “Source” geographic location and “Destination” geographic location sets the initial “Source” and “Destination” geographic locations for the recipient's geographic shopping session.

Additionally, the system adds a hotlinked button to the bottom of the postcard prompting the recipient to mail their own e-postcard. This is shown in FIG. 10 as Box 239. Once a user clicks on this button, the system opens another Internet browser on the recipient's computer and directs the browser to the e-postcard server website. Once at the website, the recipient is prompted to open an account, send an e-mail, go shopping, and take a virtual tour.

In one embodiment, the code of the e-postcard is HTML and the e-mail is readable in any web browser or HTML enabled e-mail reader. However, the code of the e-postcard is variable and can be adapted to any commonly used Internet language. In another embodiment of the present invention, the postcard server generates the e-postcard as a webpage residing on the postcard server. The system then creates an e-mail to the intended recipient containing a hotlink to the webpage that was generated. Thus, in this embodiment, when the user clicks on the hotlink, or automatically after a specified delay, an Internet browser window opens, the webpage and its associated content elements is pulled from the postcard server, and the e-postcard is displayed in the browser window.

Alternatively, the HTML or other code generated is sent to the recipient's e-mail reader which renders the e-postcard. In a preferred embodiment, the recipient's e-mail reader accesses the postcard server at the time the recipient is reading the message to acquire one or more content elements of the e-postcard.

Next, the system generates an address entry screen. The address entry screen prompts the user to enter an e-mail address and the city of an individual or entity to whom the user may wish to send postcards. Indicating a city for the recipient establishes a “Destination” geographic location if the recipient goes geographic shopping. When the system receives a response from the user indicating that they wish to enter an address, the system generates a form in which the user can enter personal information, a nickname, and an e-mail address for an individual or entity. Once the system receives the address information, the system prompts the user to enter another address or send the card. The system repeats until the user completes entry of all of the addresses that they wish to enter.

The use of a personal computer or other device connected to the Internet provides some additional features. For example, in obtaining address information, the user will be prompted to select from addresses already stored in another program on their device, such as in an electronic address book program, for example, Microsoft Outlook, Palm Desktop, Lotus Notes, and others. Additionally, a user will be able to access their device if it is linked to the Internet from another terminal to obtain address information from it.

Additionally, the system prompts the user to enter additional content, such as photos, graphics and music that can later be incorporated into e-postcards. This system will enable users who have personal content to create composite images using other content provided by the system. For example, a user can superimpose a picture of themselves onto a photo of a famous background to create the illusion on their postcard that they were at that location. This same form of content customization may be applied to other products purchased. For example, a user can impose a customized picture onto a tee-shirt.

### Payment

If the user selects fee based content, such as an item to purchase, the system checks to see if the user has an account on the postcard server. If the user does not have an account on the postcard server the user is prompted to create one.

Alternatively, the system prompts the user for payment information. The user may slide their credit or debit card into the card reader on the terminal. Alternatively, a user enters the digits off of their credit or debit card into an entry box on the screen to facilitate payment. Alternatively, the user is prompted to authorize account information to be used to charge the transaction by entering their username and password on the screen. Once payment is received, the system contacts the vendor site of the product vendor. Once the system contacts the vendor site, the system communicates a purchase order for the product ordered to the vendor. When the system receives confirmation that the purchase order has been accepted, the system charges the amount of the purchase to the user's credit or debit card, and prints a receipt of the purchase for the user. In an alternative embodiment, the user is prompted to have the receipt e-mailed to them. If the user selects this option, the user is prompted to enter their e-mail information. Once the e-mail information is received the receipt is sent to the user's e-mail account.

### System Sequences In One Embodiment Of The Present Invention

Below is an example of the sequence of events, or steps, during a sample session between a user and the system. The example employs the invention as an electronic assistant system. The system is in the form of a cellular phone that contacts to a server linked to the Internet. A telephonic system employs voice recognition and “text to speech” software and hardware, as used in a voice portal, which can be accessed from any phone. A telephonic system is “hands free” and therefore advantageous for a vehicle driver, the handicapped, the blind, and those who sometimes lack convenient access to a computer or are intimidated by using a computer.

The system is programmed to allow the user to send electronic greeting cards and postcards via the Internet, to purchase goods or services for themselves, to purchase gifts for others and have them delivered, to purchase gift certificates and have them mailed, and to allow the user to acquire Travel information. It is assumed that the well defined hierarchical addressing/cataloging scheme (a.k.a. the tree) has already been created, as well as the Geographic Location Context database. It is also assumed that a user profile has already been created for the user as indicated above, although as will be seen below, one can be created during the first use by querying the user for responses to specific questions. It is also assumed that some of the following steps and questions will be rendered unnecessary if the user asks a question that gives the system enough information to skip one or more queries to the user.

1. The User calls a toll-free number on any phone and initiates the session.

2. The server, through a digitized voice, asks the user to select a language. In one embodiment of the present invention, the user can select a language by stating the language they would like or by pressing a number that is assigned to that language and communicated to the user.

3. The server asks the user to identify themselves. In one embodiment, the user states their name and password. In an alternative embodiment, the server employs speech recognition to identify and authenticate the user automatically. Alternatively, if the person is calling from a device that is their own and that has been registered with the system as such, then the authentication procedure is unnecessary.

4. The server then prompts the user whether they would like to:

i. send a geographically distinctive greeting card,

ii. send a travel postcard

iii. send a gift,

iv. purchase a good of service, or

v. get travel advice and information.

5. If the user selects to send a geographically distinctive greeting card.

i. The user is prompted for the geographic location that they would like to send the card from.

(1) Alternatively, if the system is able to detect the location of the device being used (here a cell phone), the system asks the user if they would like to send the postcard from where they are now or from another geographic location.

(2) This is the step in which the relevant “Source” geographic location value of the Geographic Location Context is selected.

ii. The user is prompted for the name of the recipient.

(1) If a recipient profile exists, then the system uses the context and address information that exists for the recipient.

(2) If no context exists for the recipient, then the system asks the user for address information. This is the step n which the relevant “Destination” geographic location value of the Geographic Location Context is established. The system also asks a basic set of questions to establish a recipient profile containing such information as the age and sex of the recipient.

(3) The recipient's profile can be automatically updated by the system depending on which card the user sends to them.

iii. The user is prompted for the occasion and type of greeting card that they wish to send.

iv. The system merges the request for a specific occasion with the User Context of the sender and the recipient profile and selects a card.

v. The system reads a description of the card to the user, and then prompts the user to either accept the card or listen to one or more descriptions of other cards.

vi. Once a card has been selected, the system prompts the user to enter a voice message that will either be converted to text or played for the user with the card.

vii. The system prompts the user to choose additional elements for the card.

6. Once the card is complete, the system asks the user if the user would like to:

i. purchase a gift for the same recipient,

ii. send the same card to another recipient or group of recipients,

iii. send a new card to a new recipient,

iv. change to travel postcards and geographically distinctive gifts,

v. change to travel advice and information, or

vi. end the session at which time any products are sent and any financial transactions are charged to the credit card on file.

7. If the user chooses to send a travel postcard, the

i. The user is prompted for the geographic location that they would like to send the card from.

(1) Alternatively, if the system is able to detect the location of the device being used (here a cell phone), the system asks the user if they would like to send the postcard from where they are now or from another geographic location.

(2) This is the step in which the relevant “Source” location value of the Geographic Location Context is selected.

ii. The user is prompted for the name of the recipient. (Unless the user elected to send a travel postcard to the same person that the user just sent something else to in which case the recipient is already known.)

(1) If a recipient profile exists then the system uses the profile and address information that exists for the recipient.

(2) If no recipient profile exists, then the system asks the user for address information. This is the step in which the relevant “Destination” location value of the Geographic Location Context is established. The system also asks a basic set of questions to establish the recipient's profile, such as the age and sex of the recipient.

(3) The recipient's profile can be automatically updated by the system depending on which card the user sends to them.

iii. The system merges the Geographic Location Context, the User Context of both the sender and the recipient and selects a card.

iv. The system reads a description of the card to the user, and then prompts the user to either accept the card or listen to one or more descriptions of other cards.

v. Once a card has been selected, the system prompts the user to enter a voice message that will either be converted to text or played for the user with the card.

vi. The system prompts the user to choose additional elements for the card.

8. Once the card is complete the system asks the user, if the user would like to:

i. purchase a gift for the same recipient,

ii. send the same card to another recipient or group of recipients,

iii. send a new card to a new recipient,

iv. change to greeting cards,

v. change to travel advice and information, or

vi. end the session at which time any products are sent and any financial transactions are charged to the credit card on file.

9. If the user decides to send a gift or gift certificate

i. The user is prompted to enter whether the gift is for a special occasion. If the user responds affirmatively, then the user is read a list of occasions and prompted to choose one. This establishes a request for the type of gift that would be appropriate.

ii. The user is prompted for the geographic location that they would like to send the gift or gift certificate from. (Unless the user just sent another geographically specific item to someone in which case the “Destination” geographic location defaults to that “Destination” geographic location.)

(1) Alternatively, if the system is able to detect the location of the device being used (here a cell phone), the system asks the user if they would like to send the gift from where they are now or from another geographic location.

iii. The user is prompted for the name of the recipient. (Unless the user elected to send a gift to the same person that the user just sent something else to in which case the recipient has already been identified.)

(1) If a recipient profile exists, then the system uses the recipient user context and address information that exists for the recipient.

(2) If no recipient profile exists, then the system asks the user for address information. At this point the relevant “Destination” geographic location value of the Geographic Location Context is established. The system also asks a basic set of questions to establish some information in the recipient's profile, such as the age and sex of the recipient.

(3) The recipient's profile can be automatically updated by the system depending on which gift the user sends to them.

(4) The system sorts possible gifts based on “Source” location and “Destination” location values; then merges the Request Context, Geographic Location Context, the User Context of both the sender and the recipient and selects a gift or gift certificate.

(5) Alternatively, when the gift or gift certificate is sent in conjunction with a greeting card, the server correlates the data from the recipient's profile and the type of greeting card selected by the user and matches the most popular gift items that fit the occasion, holiday.

(6) Alternatively, when the gift or gift certificate is sent in conjunction with a travel postcard, the server correlates the data from the recipient's profile including the “Destination” geographic location and the “Source” geographic location specified by the user, matches it with a selection of the most popular gift items from that particular country or region, and then makes gift recommendations.

iv. The system reads a description of the gift to the user, and then prompts the user to either accept the gift or listen to one or more descriptions of other gifts.

v. Once a gift has been selected, the system prompts the user to enter a voice message that will either be converted to text or played for the user with the card.

vi. The system prompts the user to choose additional elements for the card.

10. Once the gift is complete, the system asks the user if the user would like to:

i. purchase another gift for the same recipient,

ii. send the same gift to another recipient or group of recipients,

iii. send a new gift to a new recipient,

iv. change to greeting cards,

v. change to travel postcards,

vi. change to travel advice and information, or

vii. end the session at which time any products are sent and any financial transactions are charged to the credit card on file.

11. If the user selects travel advice and information:

i. The user is prompted for the geographic location that they would like advice and information about. This selects the relevant “Source” geographic location value of the Geographic Location Context (in the case of travel information, only the “Source” location value of the Geographic Location Context is required).

(1) Alternatively, if the system is able to detect the location of the device being used (here a cell phone), the system asks the user if they would like advice and information about where they are now or about another geographic location.

ii. The system prompts the user to choose a category of travel information from the following three choices: (1) Hotel recommendations; (2) Restaurant recommendations; (3) Itinerary information; (4) A customized travel book featuring hotel restaurant and itinerary information; and (5) A customized travel magazine featuring hotel, restaurant and itinerary information coupled with geographically specific articles. The user selection determines the content that is presented to the user.

iii. If the user chose Hotel recommendations, the user is prompted for the length of stay, the particular place they are visiting, the proximity to the place of visitation preferred, the price range (low cost, moderate, or more expensive).

iv. If the user chose Restaurant recommendations, the user is prompted for the particular place they are visiting, the proximity to the place of visitation preferred, and the price range (low cost, moderate, or more expensive).

v. If the user chose Itinerary information, the user is prompted for the length of stay, whether they have children accompanying them, and how long they would like an excursion to last.

vi. The system merges the request, the Geographic Location Context and the User Context to select advice and information to offer the user.

vii. The system reads the advice and information to the user.

viii. If the user chose either the customized travel book, or the customized travel magazine, the user context, the geographic context, and the terminal context is used to sort through hotel, restaurant and itinerary information as well as articles to select content to provide to the user. The book or magazine may be in electronic or physical form and may contain print and multimedia content. The system may aggregate content from multiple other vendors to create the customized travel book or magazine.

12. Once the advice and information has been communicated to a user, the system asks the user if they would like to:

i. Make a purchase relevant to that information (e.g., to buy tickets for himself or for someone else); if the purchase items(s) are for someone else, the user is prompted to select a “Destination” geographic location to which the item(s) will be sent;

ii. obtain travel advice and information about another geographic location,

iii. send a travel postcard from the same geographic location,

iv. send a gift or gift certificate from the same geographic location,

v. change to a new gift from a new geographic location,

vi. change to greeting cards,

Vii. change to gifts,

viii. change to travel postcards, or

ix. end the session at which time any products are sent and any financial transactions are charged to the credit card on file.

Another example of an electronic assistant application for travel information is set forth below. In this example, the system is resident on a mobile laptop computer that dials into the Internet through a modem and an Internet Service Provider (ISP). In this example, a user residing in Los Angeles, wants the name and location of a good dinner restaurant in Athens, Greece, where the user will be traveling on business the following week.

The mobile laptop computer has a Terminal profile indicating the color screen, audio speakers, and other multimedia capabilities of the laptop. The user initiates the system and is dialed into the Internet and the context servers. At this point there may be a default “Source” geographic location for the terminal specified in a cookie or other file on the laptop. Alternatively, a “Source” geographic location may be selected for the terminal based upon either the telephone number dialed by the laptop to access the Internet or the telephone number of the place the laptop dialed from. Once a “Source” geographic location is selected, the device creates a Session Context and a first screen for the user based upon the Terminal Context and the “Source” geographic location.

At this point the system can be used in two ways. In a first way, considered to be a “generalized” implementation, there is no User Context specific to the user, but rather a default User Context. The system will retrieve content based on the Terminal Context, Geographic Location Context and any request made by the user. In a second use of the system, considered to be a “specific” implementation, the system prompts the user to use a User Context. The user can start a new User Context by filling out a user profile, or can use an existing User Context. Once a User Context specific to the user is started, the system can customize the content based upon the content of the specific user. It should be noted that even in a situation where there is no specific User Context available, as the user continues to use the system, a temporary User Context is being built that does influence later context selection. However, the User Context information will be lost upon exit, if no user profile is opened.

If the Terminal belongs to an individual, the device can be set to automatically log in the user. If the device does not belong to any one user, or if the user is not currently logged into the system on the device, the first screen prompts the user to enter existing account information or open a new account, so that a relevant User Context can be used or created. If the user elects to open a new account the user is prompted to enter a name and password for their account. The new user is also prompted to answer several questions to ascertain certain attributes about the user that will later be refined and augmented with other attributes. The new user is then prompted to enter financial information to make instant purchases and to allow the system to conduct financial transactions on the user's behalf.

If a User Context is selected, the User Context is merged with the Terminal Context and the Geographic Location Context (including both a “Source” location and a “Destination” location for products and services, but only a “Source” location for travel information) to create a new Session Context. At this point the system asks the user what it is they want. In one embodiment, the system asks direct questions, such as whether the user is interested in purchasing a good or service or whether the user wants Itinerary information. Once the system receives a response from the user to one of the direct questions, the system asks further clarification questions, such as what kind of good the user wishes to purchase. For the sake of this example, we will assume that the user at this point enters their request for information for a good dinner restaurant in Athens, Greece. (Alternatively, the user could just ask for good dinner reservations, and at then point can be prompted for the geographic location already selected or to select another geographic location.)

The system software resident either on the server or on the laptop parses the text of the question for request information. The system selects the relevant “Source” geographic location from the question itself, and loads the Geographic Location Context for Greece. The Geographic Location Context for Greece is merged with the User's Context to form a new Session Context. The system then analyzes the User's Context to determine the price range of restaurants that the user likes and the type of food that the user likes. In some embodiments, the system considers additional factors in selecting a restaurant, such as relevant distances from already scheduled events and hotels, or whether the user is eating similar food during the meals immediately before and after. Additionally, if the user had input more specific information into the question, such as that 30 additional guests would be joining them, then the Request Context would have been analyzed and restaurants that did not seat at least 30 people would not have been selected.

The system compares the Session Context formed from the User Context for food, the “Source” geographic location and the user request, with attributes of the content relating to food and restaurants to select one or more possible restaurants. The system displays the list of recommended restaurants with any known details about each. At this point the user can either select a restaurant, or the user can ask for more recommendations. If the user selects a restaurant, the system asks the user if they would like the system to make a reservation for them. If the user responds affirmatively, the system contacts the restaurant, and makes the reservation.

At some point after the restaurant has been visited by the user, the system prompts the user to answer some questions about whether they liked or did not like the restaurant. The user's responses are used to further update the User Context as well as the Restaurant's Context. To improve the accuracy of further selections both for the current user, and for other users who share some of the data.

The preceding description has been presented with reference to the presently preferred embodiments of the invention shown in the drawings. Workers skilled in the art and technology to which this invention pertains will appreciate that alteration and changes in the described processes and structures can be practiced without departing from the spirit, principles and scope of this invention.

Accordingly, the present invention provides a system and method for personalizing, customizing and distributing geographically distinctive products and travel information over the Internet. Although this invention has been described in certain embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be commensurate with the appendix supported by this application and its equivalents rather than the foregoing description.

1. A method of using a computer for selecting content comprising:
categorizing attributes of a user in a user database;
categorizing attributes of content elements in a content database;
identifying a geographic location;
identifying a user; and
prioritizing content elements associated with the identified geographic location for presentation to the identified user by comparing the attributes of the content and the attributes of the identified user.

2. A method of using a computer for selecting content of claim 1 further comprising:
categorizing attributes of geographic locations in a geographic location database; and
selecting content elements for the user by comparing the attributes of the content elements to attributes of the identified geographic location and the attributes of the identified user.

3. A method of using a computer for selecting content of claim 2 further comprising:
categorizing attributes of a user terminal in a database; and
further selecting a content element based upon the attributes of the user terminal.

4. A method of using a computer for selecting content of claim 1 wherein the attributes of a user comprise the references of a user.

5. A method of using a computer for selecting content of claim 1 further comprising:
assigning a source location to a content element;
assigning a destination location to a content element;
prompting the user for a source location for content;
receiving by the server of a selection of a source location;
prompting the user for a destination location for content;
receiving by the server of a selection of a destination location; and
selecting content elements based upon the source location and destination location.

6. A method of using a computer for selecting content of claim 1 further comprising:
assigning a source location to a content element;
assigning a destination location to a content element;
predefining a source location;
predefining a destination location; and
selecting content elements based upon the predefined source location and the predefined destination location.

7. A method of using a computer for selecting content of claim 1 further comprising:
prompting a user to select a desirable content attribute;
receiving by the server of a selection of a desirable content attribute;
selecting content elements based upon the received selection of a desirable content attribute.

8. A method of using a computer for selecting content of claim 7 wherein the desirable content attribute is one of the group consisting of a price, a price range, an age of a content recipient, an age range of a content recipient, a sex of a content recipient, and an occasion.

9. A method of using a computer for selecting content of claim 7 further comprising:
prompting a user to identify a new geographic location;
receiving by the server of an identity of a new geographic location;
selecting content elements associated with the new geographic location by comparing the attributes of the content to user attributes and based upon the received selection of a desirable content attribute.

10. A method of using a computer for selecting content of claim 1 further comprising:
prompting a user to select a predefined set of user attributes;
receiving by the server of a selection of a predefined set of user attributes; and
selecting content elements based upon the selected set of user attributes.

11. A method of using a computer for selecting content of claim 1 further comprising:
prompting a user to select a set of user attributes belonging at least one of the group consisting of a different user and a group of users;
receiving by the server of at least one selection from the group consisting of a different user and a group of users;
selecting content elements based upon the received selection of at least one of the group consisting of a different user and a group of users.

12. A method of using a computer for selecting content of claim 1 wherein the geographic location is identified by a global positioning system coupled to a terminal which is coupled to a server.

13. A method of using a computer for selecting content of claim 6 wherein the source geographic location is identified by a global positioning system coupled to a terminal which is coupled to a server.

14. A method of using a computer for selecting content of claim 1 wherein the geographic location is identified by prompting a user to enter a geographic location; and receiving by a server of a selected geographic location.

15. A method of using a computer for selecting content of claim 6 wherein the source geographic location is identified by prompting a user to enter a geographic location; and receiving by a server of a selected geographic location.

16. A method of using a computer for selecting content of claim 1 wherein the geographic location is identified by a connection of a user terminal to the server.

17. A method of using a computer for selecting content of claim 6 wherein the source geographic location is identified by a connection of a user terminal to a server.

18. A method of using a computer for selecting content of claim 1 further comprising modifying by a server of the attributes of the user stored in the user database based upon at least one of the group consisting of responses from a user and a user's actions.

19. A method of using a computer for selecting content of claim 1 further comprising modifying by a server of the attributes of a geographic location stored in the geographic location database based upon at least one of the group consisting of responses from a user and a user's actions.

20. A method of using a computer for selecting content of claim 1 wherein user attributes are determined by prompting the user to answer questions; receiving by a server of answers to questions; and assigning a numerical value to a tree node based upon the answer to each question.

21. A method of using a computer for selecting content of claim 2 wherein the categorizing of geographic locations is done in a tree structure having nodes; the categorizing of user attributes is in a tree structure having nodes and corresponding to the geographic location tree structure; and the categorizing of content attributes is in a tree structure having nodes and corresponding to the geographic location tree structure and the user attribute tree structure.

22. A method of using a computer for selecting content of claim 21 wherein a content element is selected by comparing each node of the geographic location tree to each node of the user attribute tree and to each node of the content element tree.

23. A method of using a computer for selecting content of claim 1 wherein the content elements are selected from the group consisting of goods, services, advertisements and information.

24. A method of using a computer for selecting content of claim 23 further comprising:
aggregating selected content elements into an electronic travel book;
assigning a source location to the electronic travel book;
assigning a destination location to the electronic travel book; assigning links to portions of the aggregated selected content to additional content having the source location and destination location of the electronic travel book.

25. A method of using a computer for selecting content of claim 23 further comprising:
aggregating selected content into a electronic travel magazine;
assigning a source location to the electronic travel magazine;
assigning a destination location to the electronic travel magazine;
assigning links to portions of the aggregated selected content to additional content having the source location and destination location of the electronic travel magazine; and
wherein the content further comprises articles.

26. A method of using a computer for selecting content of claim 25 wherein links are assigned to a portion of the aggregated selected content that depicts a product; and
wherein the links assigned to content that depicts a product link to purchase information about the product depicted.

27. A computer readable medium having stored thereon a set of instructions including instructions for:
categorizing attributes of geographic locations in a geographic location database;
categorizing attributes of a user in a user database;
categorizing attributes of content in a content database;
identifying a geographic location;
identifying a user;
selecting a content element for the user by comparing the attributes of the content elements to attributes of the identified geographic location and the attributes of the identified user.

28. A computer readable medium having stored thereon a set of instructions of claim 27 wherein the geographic location database comprises fields for storing a source location value and a destination location value.

29. A system using a computer for selecting content comprising:
a user terminal coupled to a computer network;
a geographic location database coupled to the computer network for storing geographic location attribute information;
a user attribute database coupled to the computer network for storing user attribute information;
a content database coupled to the computer network for storing content attribute information;
a server coupled to the computer network configured to receive an identified geographic location and an identified user, and configured to select a content element for the identified user by comparing the attributes of the content in the content database to attributes of the identified geographic location from the geographic location database and the attributes of the identified user from the user database.

30. A computer readable medium having stored thereon a set of instructions of claim 29 wherein the geographic location database comprises fields for storing a source location value and a destination location value.

31. A system using a computer for selecting content of claim 29 further comprising a terminal database coupled to the computer network for storing terminal attribute information; and wherein the server is further configured to:
receive an identified terminal; and
select a content element for a user by comparing attributes of the identified terminal in the terminal database to attributes of content in the content database.

32. A method using a computer of creating content for electronic postcards comprising:
providing from a server an input form to a remote sender site;
receiving by the server responsive data to the input form communicated from the remote sender site;
receiving by the server of an identification of a user associated with the responsive data; and
providing the responsive data to the user associated with the responsive data at a remote receiving site.

33. The method of using a computer of creating content for electronic postcards of claim 32 further comprising receiving from the remote sender site a monetary amount designated for a remote user associated with the responsive data to the input form.

34. A method for shopping via the Internet comprising:
placing goods and services in a database;
allowing the database to be searched based upon geographic criteria.

35. A method for sending electronic postcards comprising:
soliciting a user to send an electronic postcard from a source location;
designing an electronic postcard;
sending an electronic postcard to a receiver; and
prompting the receiver of the postcard to purchase goods from the source location of the electronic postcard.

36. A method for sending electronic postcards according to claim 35 wherein designing an electronic postcard further comprises:
prompting a user to select at least one content element from a plurality content elements;
receiving by a server of a selection of at least one content element.

37. A method for sending electronic postcards according to claim 36 wherein designing an electronic postcard further comprises:
prompting a user to select a predefined content element;
receiving by a server of a selection of a predefined content element; and
selection by the server of the predefined content element.

38. A method for sending electronic postcards according to claim 36 wherein the content elements are at least one of the group consisting of pictures, video files, audio files and links to virtual tours; and
wherein the at least one selected content element has a link to content associated with the source location of the electronic postcard and the destination location of the receiver of the postcard.

39. A method for sending electronic postcards according to claim 36 further comprising:
prompting a user to select a gift to send with the electronic postcard;
receiving a selection of a gift to send along with the electronic postcard to the receiver; and
sending a gift to the receiver.

40. A method for developing user attributes for use in a content presentation system comprising:
receiving by a server of content requests from a user;
receiving by a server of content selections by a user;
receiving by a server of navigation information from a user;
analyzing received content requests, content selections, and navigation information to establish user attributes.

41. A method of using a computer for selecting content comprising:
identifying a geographic location;
prompting a user to request a content type;
receiving by a server of a content type selection;
linking a portion of the content type to additional content associated with the identified geographic location;
providing content to a user.

42. A method of using a computer for selecting content of claim 41 wherein the content type is selected from the group consisting of travel information about the identified location, virtual tours of the identified location, interactive webcasts about the identified geographic location, tv broadcasts about the identified geographic location.
